(19) United States
(12) Patent Application Publication
(10) Pub. No.: US 2025/0375878 A1
(43) Pub. Date: Dec. 11, 2025

(54) TECHNIQUES FOR MULTI-TASK ROBOT CONTROL USING ASYMMETRIC CRITIC-GUIDED STUDENT MODELS

(71) Applicant: NVIDIA CORPORATION, Santa Clara, CA (US)

(72) Inventors: Krishnan SRINIVASAN, Palo Alto, CA (US); Eric Rainer HEIDEN, Santa Monica, CA (US); Animesh GARG, Berkeley, CA (US); Jie XU, Bellevue, WA (US)

(21) Appl. No.: 18/983,147

(22) Filed: Dec. 16, 2024

Related U.S. Application Data
(60) Provisional application No. 63/658,379, filed on Jun. 10, 2024.

(51) Int. Cl. B25J 9/16; G05B 13/02

(52) U.S. Cl. CPC B25J 9/163; G05B 13/0265

(57) ABSTRACT

Techniques for training a machine learning model to control a robot include performing, based on a first set of robot data, one or more training operations to generate one or more first trained machine learning models for performing one or more robotic tasks, expert demonstration data, and one or more trained evaluation models; and performing, based on the expert demonstration data, a set of sensor data, and first feedback generated by the one or more trained evaluation models, one or more training operations to generate a second trained machine learning model to control a robot for a plurality of robotic tasks.

### CROSS-REFERENCE TO RELATED APPLICATIONS

This application claims priority benefit of the United States Provisional Patent Application titled, “MULTI-TASK STUDENT-TEACHER DISTILLATION FOR VISION-BASED DEXTEROUS MANIPULATION,” filed on Jun. 10, 2024, and having Ser. No. 63/658,379. The subject matter of this related application is hereby incorporated herein by reference.

### BACKGROUND

### Technical Field

The embodiments of the present disclosure relate generally to robot control, machine learning, and artificial intelligence, and more specifically, to techniques for multi-task robot control using asymmetric critic-guided student models.

### Description of the Related Art

Robot control systems are used in many industries to enable precise and automated operations, improving efficiency and reducing human intervention in various tasks. In particular, robot control systems are oftentimes employed in manufacturing, autonomous vehicles, healthcare, and other applications where robots can be controlled to perform tasks with high accuracy and repeatability. For example, in manufacturing, robot arms controlled by robot control systems can handle tasks, such as welding, assembly, material handling, and/or the like, ensuring consistent quality and speed in production lines. Robot control systems are also utilized for dexterous manipulation, which includes controlling multi-fingered robotic hands to perform various tasks, such as grasping, assembling small components, handling objects with precision, and/or the like, which require coordination between the robot's fingers and high levels of control accuracy.

One conventional approach for robot control is to train a machine learning model to control a robot using reinforcement learning (RL). RL allows robots to autonomously explore different robot control strategies by trial and error, optimizing robot actions based on feedback from the environment in the form of rewards or penalties. In an RL framework, a policy refers to the control strategy used by a robot, which determines the actions the robot takes in response to the current state of the robot and/or of objects within the environment. The robot operates within the environment, taking actions and adjusting the policy based on the feedback the robot receives, enabling the robot to improve robot behavior over time and achieve better outcomes. The feedback informs the robot on how to adjust the behavior to achieve better outcomes over time. A widely employed approach within RL is the actor-critic framework, which utilizes two machine learning models: an actor model that is responsible for selecting actions for a robot to perform, and a critic model (e.g., an evaluation model) that evaluates the actions by estimating future rewards. In the actor-critic framework, the actor model is trained to refine the policy of the actor model while receiving feedback from the critic model. For example, in a robotic grasping task, the actor model could control how the robot should position a gripper based on sensor inputs, while the critic model could evaluate whether each action to re-position the gripper is likely to result in a successful grasp based on past experience. Another conventional approach for robot control is behavior cloning, where the robot learns a policy by imitating expert demonstrations rather than relying solely on trial and error as in RL. In behavior cloning, the robot is trained to mimic the actions of a human or another expert policy by observing state-action pairs from recorded expert demonstrations. The robot learns to map states of the robot and/or of objects within the environment to actions by minimizing the difference between the robot actions and the actions from the recorded expert demonstrations. For dexterous manipulation tasks, such as controlling multi-fingered robotic hands and/or the like, RL approaches often face additional challenges due to the high dimensionality of the state and action spaces, making RL approaches computationally expensive and inefficient. For dexterous manipulation tasks with vision-based control, the robot control problem is further compounded because of the need to process high-dimensional visual data from cameras or other sensors.

One drawback of conventional robot control approaches, such as RL and behavior cloning, is that conventional robot control approaches often struggle to generalize across multiple different tasks. Instead, conventional robot control approaches typically require task-specific training or demonstrations that limit the trained robot to performing one specific task. Task-specific training data or demonstrations can also be time-consuming and labor intensive to collect. Each new task requires additional data and retraining of the robot to perform the new task instead of the previous task, which includes manually gathering and labeling data specific to the new task and can be particularly challenging in environments where tasks vary widely or where new tasks are frequently introduced. In dexterous manipulation tasks, where multi-fingered robots have to adapt to various objects, shapes, interactions, and/or the like, the high-dimensional nature of the tasks further exacerbates the inefficiency of conventional robot control approaches, which are based on task-specific data and re-training. Behavior cloning relies on expert demonstrations to learn each task, meaning that for a robot to adapt to a new object or interaction, new demonstrations must be collected, often involving human experts performing the task repeatedly. Similar to behavior cloning, RL approaches need to explore the environment of each task separately, consuming considerable time and computational resources to re-train the policy for each specific task. Accordingly, conventional robot control approaches can typically only be used to train a robot to perform one specific task at a time, while being unable to adapt to changing conditions or new tasks without significant reconfiguration and re-training.

As the foregoing illustrates, what is needed in the art are more effective techniques for multi-task robot control.

### SUMMARY

One embodiment of the present disclosure sets forth a computer-implemented method for training a machine learning model to control a robot. The method includes performing, based on a first set of robot data, one or more training operations to generate one or more first trained machine learning models for performing one or more robotic tasks, expert demonstration data, and one or more trained evaluation models; and performing, based on the expert demonstration data, a set of sensor data, and first feedback generated by the one or more trained evaluation models, one or more training operations to generate a second trained machine learning model to control a robot for a plurality of robotic tasks.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques enable robot control systems to generalize across multiple tasks, without requiring task-specific retraining. The disclosed techniques use expert critic feedback from various trained expert critic model and a structured action space through a trained codebook for cross-task learning, reducing the need for laborious manual data collection and retraining for each new task. Another advantage of the disclosed techniques is that, by using a multi-stage training approach that combines expert critic models trained on privileged data with a high-dimensional student model, the disclosed techniques facilitate faster adaptation to new tasks or changing conditions. These technical advantages provide one or more technological improvements over prior art approaches.

### BRIEF DESCRIPTION OF THE DRAWINGS

So that the manner in which the above recited features of the various embodiments can be understood in detail, a more particular, description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A is a more detailed illustration of the model trainer of FIG. 1 training expert critic models and expert actor models, according to various embodiments;

FIG. 3B is a more detailed illustration of the model trainer of FIG. 1 training a student actor model, according to various embodiments;

FIG. 4 is a more detailed illustration of the robot control application of FIG. 1, according to various embodiments;

FIG. 5A is a more detailed illustration of the first phase of training of a student actor model of FIG. 1, according to various embodiments;

FIG. 5B is a more detailed illustration of the second phase of training of the student actor model of FIG. 1 during inference, according to various embodiments;

FIG. 6 sets forth a flow diagram of method steps for training the student actor model of FIG. 1, according to various embodiments;

FIG. 7 sets forth a flow diagram of method steps for training expert critic models and expert actor models, according to various embodiments;

FIG. 8 sets forth a flow diagram of method steps for training a student actor model, according to various embodiments;

FIG. 9 sets forth a flow diagram of method steps for training a codebook, action encoder, and action decoder of a student actor model, according to various embodiments; and

FIG. 10 sets forth a flow diagram of method steps for controlling a robot using a trained student actor model, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### General Overview

Embodiments of the present disclosure provide techniques for multi-task robot control using asymmetric critic-guided student models. The disclosed techniques include a two-stage training approach. In the first stage, expert actor models and expert critic models are trained on various tasks using privileged data, such as joint positions of a robot, forces, velocities, and states of objects within a virtual environment, that are generated by a simulator. During the first stage of training, expert demonstration data is collected based on the actions generated by the expert actor models. In the second stage, a student actor model, which processes sensor data, such as visual inputs and proprioceptive data, is trained using a combination of a behavior cloning loss derived from the expert demonstration data and a distillation loss calculated using the trained expert critic models in the first stage. The aggregate feedback uses evaluations from various expert critic models corresponding to various tasks that are being performed during training. After training, the student actor model can be deployed to control a robot by processing real-world sensor inputs and generating robot actions to perform multiple tasks.

The robot control techniques of the present disclosure have many real-world applications. For example, the robot control techniques could be used to control a physical robot in a real-world environment or a simulated robot in a virtual environment. As another example, the robot control techniques could be used to control other characters having movable joints like a robot.

The above examples are not in any way intended to be limiting. As persons skilled in the art will appreciate, as a general matter, the robot control techniques described herein can be implemented in any suitable application.

### System Overview

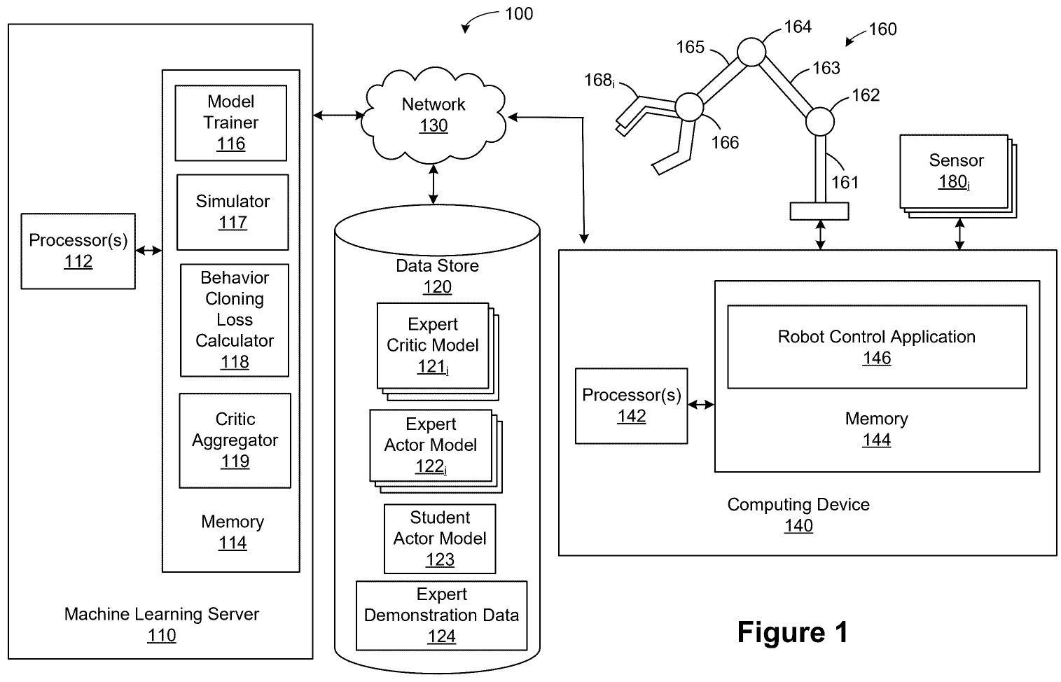

FIG. 1 illustrates a block diagram of a computer-based system configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), and/or any other suitable network. Machine learning server 110 includes, without limitation, processor(s) 112 and a memory 114. Memory 114 includes, without limitation, a model trainer 116, a simulator 117, a behavior cloning loss calculator 118, and a critic aggregator 119. Data store 120 includes, without limitation, one or more expert critic models 121ᵢ (referred to herein collectively as expert critic models 121 and individually as an expert critic model 121), one or more expert actor model 122ᵢ (referred to herein collectively as expert actor models 122 and individually as an expert actor model 122), a student actor model 123 and expert demonstration data 124. Critic models are also referred to herein as “evaluation models.” Computing device 140 includes, without limitation, processor(s) 142 and a memory 144. Memory 144 includes, without limitation, a robot control application 146.

As shown, model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random access memory (RAM), a read-only memory (ROM), an erasable programmable read-only memory (EPROM or Flash ROM), or any suitable combination of the foregoing. In at least one embodiment, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In at least one embodiment, any combination of the processor(s) 112, the system memory 114, and/or a GPU(s) can be included in and/or replaced with any type of virtual computing system, distributed computing system, and/or cloud computing environment, such as a public, private, or a hybrid cloud system.

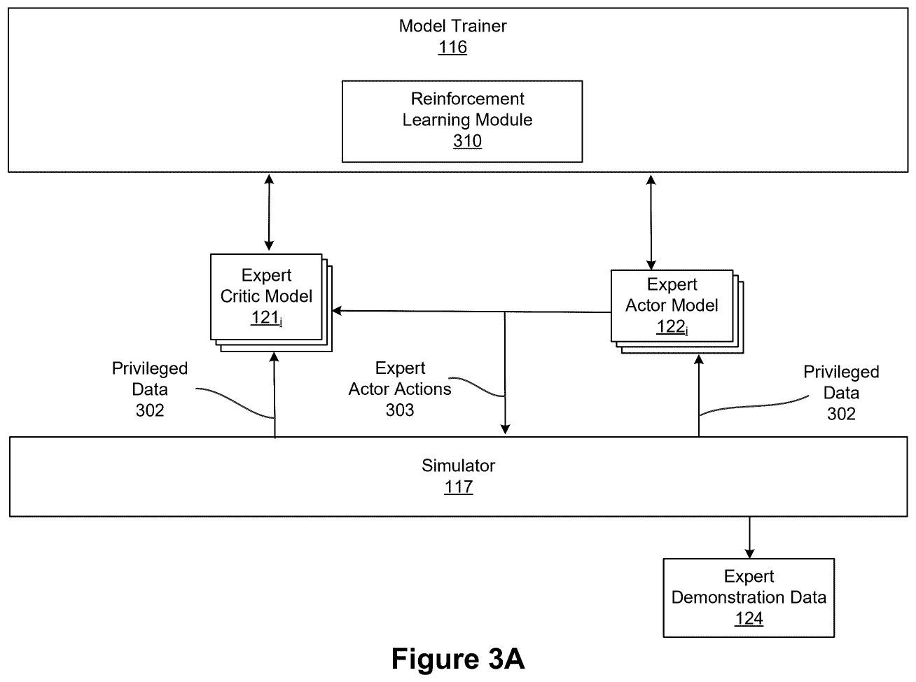

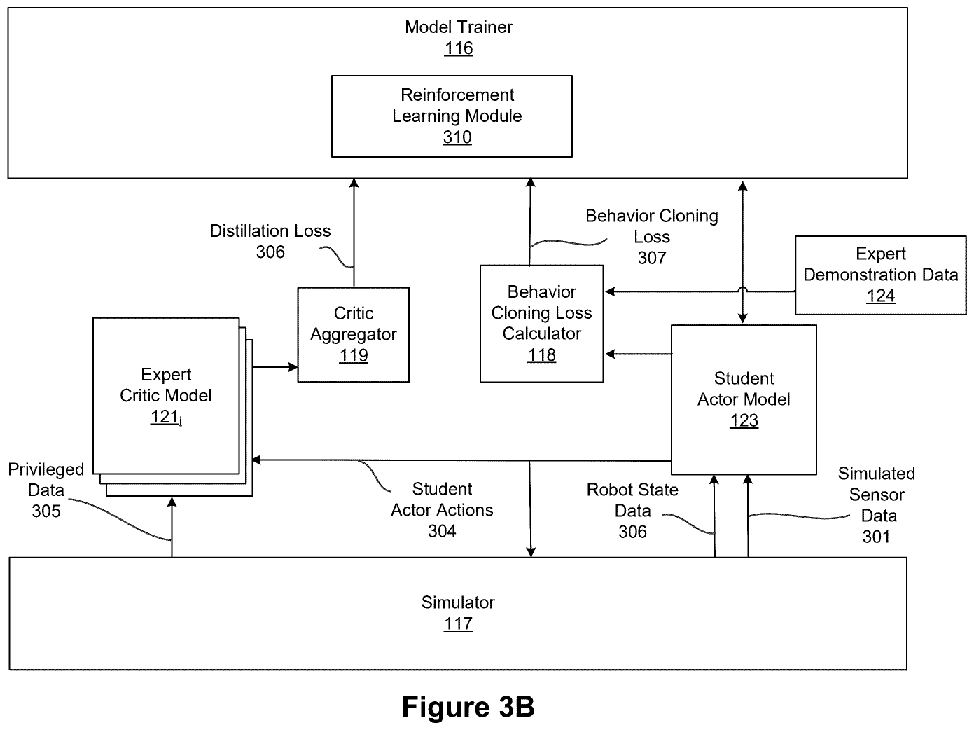

As shown, machine learning server 110 includes, without limitation, model trainer 116, simulator 117, behavior cloning loss calculator 118, and critic aggregator 119. In at least one embodiment, the model trainer 116 is configured to train one or more machine learning models using simulator 117, including but not limited to expert actor critic models 121, expert actor models 122, and student actor model 123. In such cases, student actor model 123 is trained to generate actions for a robot 160 to perform a task based on a goal and sensor data acquired via one or more sensors 180ᵢ (referred to herein collectively as sensors 180 and individually as a sensor 180). For example, in at least one embodiment, the sensors 180 can include one or more cameras, one or more RGB (red, green, blue) cameras, one or more depth (or stereo) cameras (e.g., cameras using time-of-flight sensors), one or more LiDAR (light detection and ranging) sensors, one or more RADAR sensors, one or more ultrasonic sensors, any combination thereof, etc. Techniques for training expert actor models 122, student actor model 123, and expert critic models 121 using simulator 117, are discussed in greater detail herein in conjunction with at least FIGS. 3A and 3B. Training data and/or trained (or deployed) machine learning models, including student actor model 123 and expert critic models 121, expert actor models 122, and expert demonstration data 124 can be stored in the data store 120. In at least one embodiment, the data store 120 can include any storage device or devices, such as fixed disc drive(s), flash drive(s), optical storage, network attached storage (NAS), and/or a storage area-network (SAN). Although shown as accessible over the network 130, in at least one embodiment, the machine learning server 110 can include the data store 120.

As shown, a robot control application 146 that utilizes the trained student actor model 123 is stored in a system memory 144, and executes on one or more processors 142, of the computing device 140. Once trained, student actor model 123 can be deployed, such as via robot control application 146, to control a physical robot in a real-world environment, such as robot 160. In various embodiment, the trained student actor model 123 is deployed for use with virtual environments included in simulator 117, where a virtual model of the robot is simulated within a virtual environment, such as a digital twin or a simulation platform. In the virtual deployment, robot control application 146 interfaces with a virtual representation of robot 160, such as using simulator 117, enabling testing, validation, and refinement of control strategies

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168ᵢ (referred to herein collectively as fingers 168 and individually as a finger 168) that can be controlled to grip an object. For example, in at least one embodiment, the robot 160 can include a locked wrist and multiple (e.g., four) fingers. Although an example robot 160 is shown for illustrative purposes, in at least one embodiment, techniques disclosed herein can be applied to control any suitable robot.

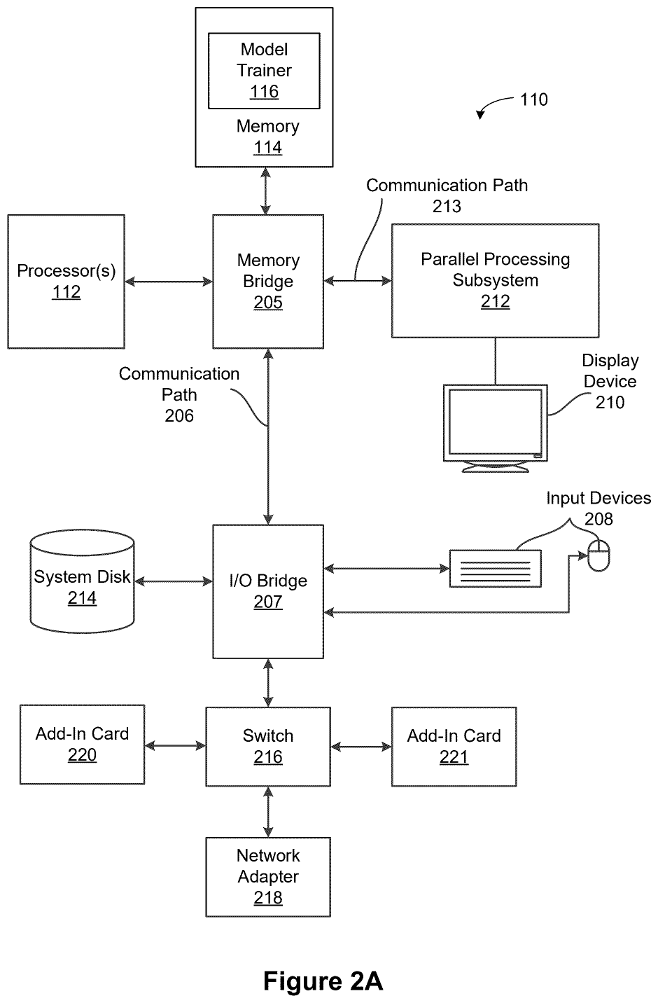

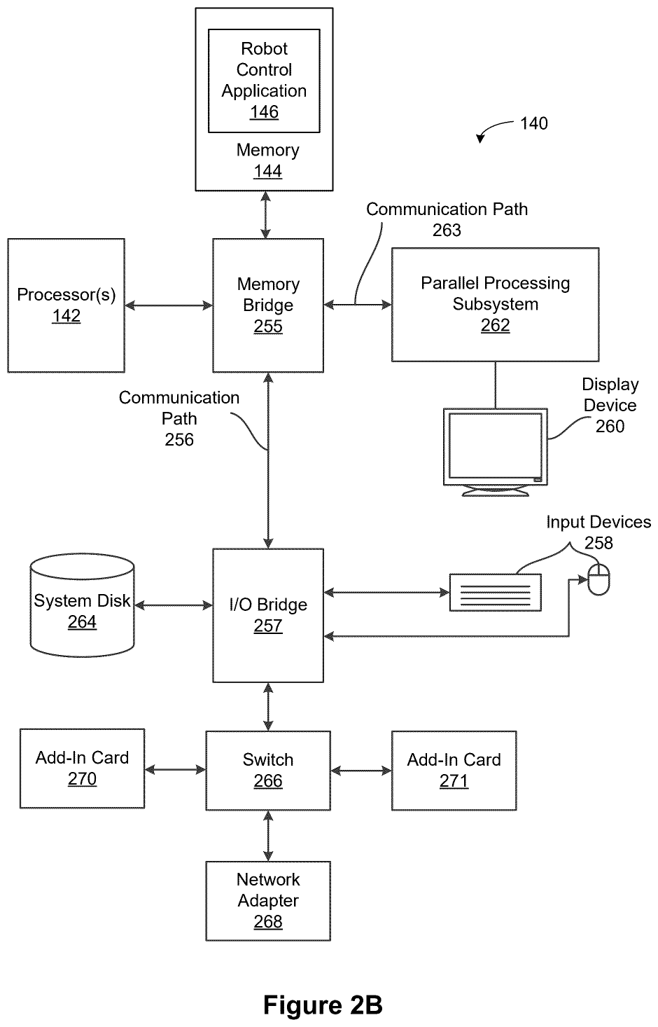

FIG. 2A is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the machine learning server 110 is a server machine operating in a data center or a cloud computing environment that provides scalable computing resources as a service over a network.

In some embodiments, the machine learning server 110 includes, without limitation, the processor(s) 112 and the memory(ies) 114 coupled to a parallel processing subsystem 212 via a memory bridge 205 and a communication path 213. The memory bridge 205 is further coupled to an I/O (input/output) bridge 207 via a communication path 206, and I/O bridge 207 is, in turn, coupled to a switch 216.

In one embodiment, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In at least one embodiment, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In at least one embodiment, the switch 216 is configured to provide connections between I/O bridge 207 and other components of the machine learning server 110, such as a network adapter 218 and various add-in cards 220 and 221.

In at least one embodiment, the I/O bridge 207 is coupled to a system disk 214 that may be configured to store content and applications and data for use by the processor(s) 112 and the parallel processing subsystem 212. In one embodiment, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In at least one embodiment, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry.

In at least one embodiment, the parallel processing subsystem 212 incorporates circuitry optimized (e.g., that undergoes optimization) for general purpose and/or compute processing. The system memory 114 includes at least one device driver configured to manage the processing operations of one or more parallel processing units (PPUs) within the parallel processing subsystem 212. In addition, the system memory 114 includes the model trainer 116. Although described herein with respect to the model trainer 116, techniques disclosed herein can also be implemented, either entirely or in part, in other software and/or hardware, such as in the parallel processing subsystem 212.

In some embodiments, the parallel processing subsystem 212 may be integrated with one or more of the other elements of FIG. 1 to form a single system. For example, the parallel processing subsystem 212 may be integrated with processor 112 and other connection circuitry on a single chip to form a system on a chip (SoC).

In at least one embodiment, the processor(s) 112 includes the primary processor of machine learning server 110, controlling and coordinating operations of other system components. In at least one embodiment, the processor(s) 112 issues commands that control the operation of PPUs. In at least one embodiment, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in at least one embodiment, system memory 114 could be connected to the processor(s) 112 directly rather than through the memory bridge 205, and other devices may communicate with the system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 1 may not be present. For example, the switch 216 could be eliminated, and the network adapter 218 and the add-in cards 220, 221 would connect directly to the I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs. FIG. 2A is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the machine learning server 110 is a server machine operating in a data center or a cloud computing environment that provides scalable computing resources as a service over a network.

In some embodiments, the machine learning server 110 includes, without limitation, the processor(s) 112 and the memory(ies) 114 coupled to a parallel processing subsystem 212 via a memory bridge 205 and a communication path 213. The memory bridge 205 is further coupled to an I/O (input/output) bridge 207 via a communication path 206, and I/O bridge 207 is, in turn, coupled to a switch 216.

In one embodiment, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In at least one embodiment, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In at least one embodiment, the switch 216 is configured to provide connections between I/O bridge 207 and other components of the machine learning server 110, such as a network adapter 218 and various add-in cards 220 and 221.

In at least one embodiment, the I/O bridge 207 is coupled to a system disk 214 that may be configured to store content and applications and data for use by the processor(s) 112 and the parallel processing subsystem 212. In one embodiment, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In at least one embodiment, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry.

In at least one embodiment, the parallel processing subsystem 212 incorporates circuitry optimized (e.g., that undergoes optimization) for general purpose and/or compute processing. The system memory 114 includes at least one device driver configured to manage the processing operations of one or more parallel processing units (PPUs) within the parallel processing subsystem 212. In addition, the system memory 114 includes the model trainer 116. Although described herein with respect to the model trainer 116, techniques disclosed herein can also be implemented, either entirely or in part, in other software and/or hardware, such as in the parallel processing subsystem 212.

In some embodiments, the parallel processing subsystem 212 may be integrated with one or more of the other elements of FIG. 1 to form a single system. For example, the parallel processing subsystem 212 may be integrated with processor 112 and other connection circuitry on a single chip to form a system on a chip (SoC).

In at least one embodiment, the processor(s) 112 includes the primary processor of machine learning server 110, controlling and coordinating operations of other system components. In at least one embodiment, the processor(s) 112 issues commands that control the operation of PPUs. In at least one embodiment, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in at least one embodiment, system memory 114 could be connected to the processor(s) 112 directly rather than through the memory bridge 205, and other devices may communicate with the system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 1 may not be present. For example, the switch 216 could be eliminated, and the network adapter 218 and the add-in cards 220, 221 would connect directly to the I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a more detailed illustration of the computing device 140 of FIG. 1, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the computing device 140 is a server machine operating in a data center or a cloud computing environment that provides scalable computing resources as a service over a network.

In some embodiments, the computing device 140 includes, without limitation, the processor(s) 142 and the memory(ies) 144 coupled to a parallel processing subsystem 262 via a memory bridge 255 and a communication path 263. The memory bridge 255 is further coupled to an I/O (input/output) bridge 257 via a communication path 256, and I/O bridge 257 is, in turn, coupled to a switch 266.

In one embodiment, the I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In at least one embodiment, the computing device 140 may be a server machine in a cloud computing environment. In such embodiments, the computing device 140 may not include input devices 258, but may receive equivalent input information by receiving commands (e.g., responsive to one or more inputs from a remote computing device) in the form of messages transmitted over a network and received via the network adapter 268. In at least one embodiment, the switch 266 is configured to provide connections between I/O bridge 267 and other components of the computing device 140, such as a network adapter 268 and various add-in cards 270 and 271.

In at least one embodiment, the I/O bridge 257 is coupled to a system disk 264 that may be configured to store content and applications and data for use by the processor(s) 142 and the parallel processing subsystem 262. In one embodiment, the system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In some embodiments, other components, such as universal serial bus or other port connections, compact disc drives, digital versatile disc drives, film recording devices, and the like, may be connected to the I/O bridge 257 as well.

In some embodiments, the memory bridge 255 may be a Northbridge chip, and the I/O bridge 257 may be a Southbridge chip. In addition, the communication paths 256 and 263, as well as other communication paths within the computing device 140, may be implemented using any technically suitable protocols, including, without limitation, AGP (Accelerated Graphics Port), HyperTransport, or any other bus or point-to-point communication protocol known in the art.

In at least one embodiment, the parallel processing subsystem 262 comprises a graphics subsystem that delivers pixels to an optional display device 260 that may be any conventional cathode ray tube, liquid crystal display, light-emitting diode display, and/or the like. In such embodiments, the parallel processing subsystem 262 may incorporate circuitry optimized for graphics and video processing, including, for example, video output circuitry.

In at least one embodiment, the parallel processing subsystem 262 incorporates circuitry optimized (e.g., that undergoes optimization) for general purpose and/or compute processing. The system memory 114 includes at least one device driver configured to manage the processing operations of one or more parallel processing units (PPUs) within the parallel processing subsystem 212. In addition, the system memory 114 includes the robot control application 146. Although described herein with respect to the robot control application 146, techniques disclosed herein can also be implemented, either entirely or in part, in other software and/or hardware, such as in the parallel processing subsystem 262.

In some embodiments, the parallel processing subsystem 262 may be integrated with one or more of the other elements of FIG. 1 to form a single system. For example, the parallel processing subsystem 262 may be integrated with processor 142 and other connection circuitry on a single chip to form a system on a chip (SoC).

In at least one embodiment, the processor(s) 142 includes the primary processor of computing device 140, controlling and coordinating operations of other system components. In at least one embodiment, communication path 263 is a PCI Express link. In at least one embodiment, the processor(s) 142 issues commands that control the operation of PPUs. In at least one embodiment, communication path 163 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 262, may be modified as desired. For example, in at least one embodiment, system memory 144 could be connected to the processor(s) 142 directly rather than through the memory bridge 255, and other devices may communicate with the system memory 144 via the memory bridge 255 and the processor 142. In other embodiments, the parallel processing subsystem 262 may be connected to the I/O bridge 257 or directly to the processor 142, rather than to the memory bridge 255. In still other embodiments, the I/O bridge 257 and the memory bridge 255 may be integrated into a single chip instead of existing as one or more discrete devices. In certain embodiments, one or more components shown in FIG. 1 may not be present. For example, the switch 266 could be eliminated, and the network adapter 268 and the add-in cards 279 and 271 would connect directly to the I/O bridge 257. Lastly, in certain embodiments, one or more components shown in FIG. 1 may be implemented as virtualized resources in a virtual computing environment, such as a cloud computing environment. In particular, the parallel processing subsystem 262 may be implemented as a virtualized parallel processing subsystem in at least one embodiment. For example, the parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Asymmetric Critic-Guided Student Actor Models for Robot Control

FIG. 3A is a more detailed illustration of the model trainer 116 of FIG. 1 training expert critic models 121 and expert actor models 122, according to various embodiments. In some embodiments, model trainer 116 performs a two-step training process. In the first step, shown in FIG. 3A, model trainer 116 trains low-dimensional expert actor models 122 and expert critic models 121 using privileged data 302, which includes low-dimensional state information from simulator 117 that may not be available in real-world scenarios. Each of expert critic models 121 and expert actor models 122 is trained to perform a single robotic task. During the first step, expert demonstration data 124 is collected, which includes the states, actions, and rewards generated by the expert actor models 122 for various tasks. In the second step, which is described in conjunction with FIG. 3B, model trainer 116 trains high-dimensional student actor model 123 using a distillation loss calculated from aggregated expert critic feedback from the trained expert critic models 121 from the first step, a behavior cloning loss (calculated by comparing student actor actions with expert actor actions included in expert demonstration data 124), and simulated sensor data that replicates real-world conditions generated by simulator 117, which can include higher dimensional data than privileged data. In some embodiments, during the second step, model trainer 116 trains student actor model 123 based on a new set of privileged data generated by simulator 117. The two-step training process uses an asymmetric approach, where expert critic models 121 are trained with low-dimensional, privileged data 302 in the first step. The trained expert critic models 121 provide feedback for the second step, where the high-dimensional student actor model 123 is trained using the behavior cloning loss from expert demonstrations 124 and simulated sensor data. The asymmetry, with privileged data 302 in the first step and real-world-like data in the second step, helps the student actor model 123 learn in high-dimensional environments and generalize across multiple tasks.

As shown in FIG. 3A, model trainer 116 includes, without limitation, a reinforcement learning module 310. In some embodiments, model trainer 116 uses reinforcement learning module 310 in interaction with simulator 117 to train expert critic models 121 and expert actor models 122 for various robotic tasks.

Simulator 117 provides a virtual environment which processes robot actions, such as actions output by expert actor models 122 or student actor model 123, and generates privileged data and simulated sensor data, which is higher dimensional than the privileged data. Privileged data 302 can include detailed state information about the environment and/or robot 160, such as exact object positions, velocities, joint positions and orientations, pairwise net contact forces between bodies, internal states, and/or the like, at least some of which may not be available in real-world applications due to sensor limitations but can be obtained from simulator 117. For example, simulator 117 could provide exact measurements of contact forces at each point of interaction between a robotic manipulator and an object, as well as the precise positions and velocities of all objects in the environment. Additionally, simulator 117 generates simulated sensor data, which can replicate the real-world data that robot sensors 180 capture during actual deployment. Simulated sensor data can include visual data from virtual cameras, such as RGB images, depth images, and/or the like, and tactile data from virtual sensors embedded in robotic grippers or arms and/or the like. In some embodiments, simulator 117 can simulate various sensor factors such as lighting variations, noise, sensor inaccuracies, and/or the like, to ensure that the generated simulated sensor data is as realistic as possible. For example, in the case of a visuotactile sensor, simulator 117 could simulate both the tactile feedback from the contact between a sensor and objects as well as the associated visual images of the deformation of the sensor surface. The tactile data can include details such as normal and shear forces at each contact point.

Expert actor models 122 are machine learning models, such as neural networks, which process low-dimensional privileged data 302 to generate expert actor actions 303 (e.g., an action for the robot to execute in simulator 117). Expert actor actions 303 are generated at each time step and specify robot motion for the next period of time (e.g., a fraction of a second) to perform at least part of a task. Expert actor actions 303 can include commands such as adjusting the movement direction, speed, or internal configurations of robot 160 to manipulate an object, move toward a specific location, or adjust joint angles for a short period of time in the future. At each subsequent time step, new actions are generated based on updated privileged data 302, allowing robot 160 to continually adapt behavior over sequential intervals. In some embodiments, model trainer 116 trains expert actor models 122 in interaction with expert critic models 121 and simulator 117 so that expert actor actions maximize an expected cumulative reward over time. In some examples, expert actor models 118 includes a long-term-short-term (LSTM) network and a multi-layer perceptron (MLP).

Expert critic models 121 are machine learning models, such as neural networks, which process low-dimensional privileged data 302 from simulator 117 and an action generated by an actor model, such as expert actor models 122 or student actor model 123, and generate expert critic feedback. For example, if an actor model generates a robot action for the robot 160 to grasp an object with a specific force and position, expert critic models 121 could evaluate the resulting state of robot 160 and the object, such as whether the object was successfully grasped and moved without slipping. In some embodiments, during training, expert critic models 121 evaluates the actions generated by an actor model, such as expert actor models 122 or student actor model 123, by estimating the value of the resulting state, which represents the expected future rewards if the actor model continues to follow the current policy. For example, if the robot task is to place an object in a specific location, expert critic models 121 could estimate how close the object is to the target and how stable the grip of robot 160 is, projecting the long-term outcome if robot 160 continues along the current trajectory. In some embodiments, expert critic models 121 generate expert critic feedback in the form of value estimates, advantage values, and/or the like, which indicate how good or bad a particular action was in comparison to other possible actions. Model trainer 116 uses expert critic feedback to update the actor models, improving the robot control capabilities of the actor models over multiple iterations of training.

In some embodiments, reinforcement learning module 116 models the robotic task, such as contact-rich manipulation and/or the like, as a Markov decision process (MDP), represented by the tuple (S, ρ₀, A, r, T, γ), where S is the state space, representing the full state of the robot 160 and environment included in privileged data 302, ρ₀ is the initial state distribution, describing the probability distribution over the starting states, A is the action space, including of all possible actions the robot 160 can take, r(s, a, s′) is the reward function, which assigns a scalar reward when transitioning from state s to state s′ by taking action a, T(s′|s, a) is the transition distribution, describing the probability of reaching state s′ after taking action a in state s, and γϵ[0,1) is the discount factor, determining the importance of future rewards.

In some embodiments, reinforcement learning module 310 trains a set of k single-task expert actor models

$$122 {π}_{{θ}_{actor}^{i}}$$

and k expert critic models

$$121 {Q}_{{θ}_{critic}^{i}}$$

for specific robotic tasks, where iϵ{1, 2, . . . , k} is a task identifier. Each robotic task i is associated with a state-based policy trained using reinforcement learning module 310, where the task-specific policy

$${π}_{{θ}_{a c t o r}^{i}}$$

maps the state sₜϵS (which includes privileged data 302 not available in real-world settings) to an action aₜ ϵA that maximizes an expected cumulative reward for that robotic task. In some examples, the goal of the reinforcement learning module 310 is to find a policy

$${π}_{{θ}_{a c t o r}^{i}} ,$$

where the policy maps the system's states sϵ [symbol] , such as sensor data, to actions aϵA that maximize the expected cumulative reward:

$${G}_{t} = {𝔼}_{{π}_{{θ}_{a c t o r}^{i}}} [ {Σ}_{k = 0}^{∞} {γ}^{k} r ( {s}_{t + k} , {a}_{t + k} , {s}_{t + k + 1} ) ] . \qquad ( Equation 1 )$$

In some embodiments, for each robotic task iϵ{1, 2, . . . , k}, at t=0 with t being the iteration index, model trainer 116 initializes the parameters of the ith expert critic model from expert critic models 121 and the ith expert actor model from the expert actor models 122 randomly, and simulator 117 generates random privileged data 302 s₀. Then, the ith expert actor model, parameterized by

$${θ}_{actor}^{i} ,$$

generates expert actor actions

$$303 {a}_{t} = {π}_{{θ}_{a c t o r}^{i}} ( {s}_{t} ) ,$$

which is applied in the simulation environment included in simulator 117. Simulator 117 processes student expert actions 303 and generates privileged data 302 sₜ₊₁. The ith expert critic model processes both privileged data 302 and expert actor actions 303 to generate expert critic feedback

$${θ}_{critic}^{i} ,$$

that is used to update the ith expert actor model. In some examples, the ith expert critic model, parameterized by

$${θ}_{c ⌜ i t i c}^{i} ,$$

evaluates expert actor actions 303 in terms of expected cumulative reward starting from state sₜ₊₁

$${Q}_{{θ}_{c r i t i c}^{i}} ( {s}_{t} , {a}_{t} ) = 𝔼 [ {G}_{t} \vert {s}_{t} , {a}_{t} ] . \qquad ( Equation 2 )$$

The ith expert critic model also updates the value function

$${V}_{{θ}_{c r i t i c}^{i}} ( {s}_{t + 1} ) ,$$

which is the expected cumulative reward starting from state sₜ₊₁. Subsequently, reinforcement learning module 310 optimizes the policy

$${n}_{{θ}_{a c t o r}^{i}}$$

using expert critic feedback

$${Q}_{{θ}_{c r i t i c}^{i}} .$$

In some examples, reinforcement learning module 310 maximize the expected reward in Equation 1 by updating the parameters

$${θ}_{actor}^{i}$$

of the ith expert actor model based on the evaluation of the ith expert critic model of the actions (e.g., expert critic feedback). Reinforcement learning module 310 adjusts the parameters of expert actor models 122 to improve the performance of expert actor models 122 over time. In some examples, reinforcement learning module 310 can use the Temporal Difference (TD) error, calculated as:

$${δ}_{t} = {r}_{t} + γ {V}_{{θ}_{c r i t i c}^{i}} ( {s}_{t + 1} ) - {Q}_{{θ}_{c r i t i c}^{i}} ( {s}_{t} , {a}_{t} ) , \qquad ( Equation 3 )$$

where rₜ=r(sₜ, aₜ, sₜ₊₁) is the instantaneous reward at time step t. Reinforcement learning module 310 updates the parameters

$${θ}_{critic}^{i}$$

of the ith expert critic model to reduce the TD error in Equation 3, improving the ability of the ith expert critic model to evaluate the ith expert actor model accurately based on privileged data 302 and expert actor actions 303. For example, in some embodiments, reinforcement learning module 310 can minimize the loss function of the critic (e.g., the Bellman loss), which is defined as:

$${L}^{critic} ( {θ}_{critic}^{i} ) = {𝔼}_{t} [ {δ}_{t}^{2} ] . \qquad ( Equation 4 )$$

In some embodiments, reinforcement learning module 310 iteratively updates the parameters of the ith expert actor model and the ith expert critic model. For example, the parameters of the ith expert actor model,

$${θ}_{actor}^{i} ,$$

can be updated as follows:

$${θ}_{actor}^{i} ← {θ}_{a ctor}^{i} + {α}_{a ctor}^{i} {∇}_{{θ}_{a c t o r}^{i}} {G}_{t} , \qquad ( Equation 5 )$$

where

$${α}_{actor}^{i}$$

is the learning rate for the ith expert actor model and

$${∇}_{{θ}_{a c t o r}^{i}}$$

is the gradient of the expected cumulative reward in Equation 1 with respect to the parameters

$${θ}_{actor}^{i} .$$

Similarly, the parameters

$${θ}_{critic}^{i}$$

of the ith expert critic model can be updated to minimize the TD error:

$${θ}_{critic}^{i} ← {θ}_{critic}^{i} - {α}_{critic}^{i} {∇}_{{θ}_{critic}^{i}} {L}^{critic} ( {θ}_{critic}^{i} ) , \qquad ( Equation 6 )$$

where

$${α}_{critic}^{i}$$

is the learning rate for training the ith expert critic model. In some embodiments, model trainer 116 trains k expert critic models 121 and k expert actor models 122 iteratively until a stopping criterion is met, such as reaching a maximum number of iterations, a plateauing loss function, and/or the like. Once the training of expert critic models 121 and expert actor models 122 is complete, model trainer 116 stores expert critic models 121 in data store 120, or elsewhere.

In some embodiments, during training, model trainer 116 collects expert demonstration data 124. In such cases, expert demonstration data 124 includes the states, actions, and rewards generated by expert actor models 122 as well as observations (e.g., sensor data from simulator 117) during training for each robotic task i=1, . . . , k. For example, expert demonstration data 124 can be represented as

$$D = {\{ {( {s}_{t} , {o}_{t} , {a}_{t}^{expert} , {r}_{t} )}_{t = 1}^{N} \}}_{i = 1}^{k} ,$$

where oₜ are the observations included in senor data,

$${a}_{t}^{expert}$$

are expert actor actions 303, and N is the number of data points for each task.

FIG. 3B is a more detailed illustration of the model trainer 116 of FIG. 1 training the student actor model 123, according to various embodiments. As shown, model trainer 116 trains student actor model 123 using the trained expert critic models 121, expert demonstration data 124, and simulator 117.

Student actor model 123 is a machine learning model, such as a neural network, which processes sensor data and privileged data 305 and generates student actor actions 304. In some embodiments, student actor model 123 processes noisy, incomplete, and high-dimensional inputs, such as camera images, tactile sensor readings, and/or the like, from sensors 180 to generate student actor actions 304 that allow robot 160 to interact with the environment. For example, in a robotic manipulation task, student actor model 123 could process visual inputs from a camera mounted on a robot arm and tactile data from sensors embedded in a robot gripper. The visual input can include an RGB image of the object to be grasped, while the tactile sensor data provides information about the force applied by the gripper on the object. Student actor model 123 processes the sensor data and robot state data 306 and generates robot actions, such as adjusting the gripper position or force, to successfully manipulate the object without dropping or damaging the object. During training, student actor model 123 processes simulated sensor data 301 generated by simulator 117 instead of real-world sensor data. In some examples, student actor model 123 includes various types of neural networks, such as a convolutional neural network (CNN) for processing high-dimensional visual inputs, transformers for handling relationships between input features across time steps or tasks, a LSTM network for handling sequential data with temporal dependencies, and a MLP for processing lower-dimensional sensor readings or states. In at least one embodiment, at every time step t, student actor model 123 generates student actor actions 304 in action chunks â_{t:t+1}={âₜ, âₜ₊₁, . . . , âₜ₊₁}, where l>0 is a prediction horizon.

In some embodiments, reinforcement learning module 310 trains student actor model 123 using distillation loss 306, which is calculated by critic aggregator 119 using trained expert critic models 121, and behavior cloning loss 307, which is calculated using expert demonstration data 124. In some embodiments, the goal of the reinforcement learning module 310 is to find a policy π_{θ}_{_{student}}, where the policy maps the robot observations oϵ0, such as simulated sensor data 301 or sensor data acquired by sensors 180, to actions aϵA that maximize an expected cumulative reward, such as the expected cumulative reward in Equation 1. In order to train student actor model 123, at t=0 with t being the iteration index, reinforcement learning module 310 initializes the parameters θ_{student} of student actor model 123 with random values, and simulator 117 generates random simulated sensor data 301 o₀ and privileged data 305 s₀. Student actor model 123 generates student actor actions 304 â_{0:l}, Student actor actions 304 are applied in the simulation environment included in simulator 117. Simulator 117 processes student actor actions 304 and generates simulated sensor data 301 oₜ₊₁ and privileged data 305 sₜ₊₁ Each of the k trained expert critic models 122 evaluates student actor actions 304 and generates an expert feedback

$${Q}_{{θ}_{critic}^{i}} ( {s}_{t + 1} , {\hat{a}}_{t + 1} ) ,$$

based on privileged data 305 and student actor actions 304. Each expert critic feedback

$${Q}_{{θ}_{critic}^{i}} ( {s}_{t + 1} , {\hat{a}}_{t + 1} )$$

provides a value-based estimate of how optimal student actor actions 304 for each task iϵ{1, . . . , k} are. Critic aggregator 119 initially processes expert critic feedback from expert critic models 121 across various tasks and generates the aggregated critic feedback,

$${Q}_{agg} = [ {Q}_{{θ}_{critic}^{1}} , … , {Q}_{{θ}_{critic}^{k}} ] .$$

In some examples, given a robotic task i, critic aggregator 119 selects the specific task-relevant critic

$${Q}_{{θ}_{critic}^{i}}$$

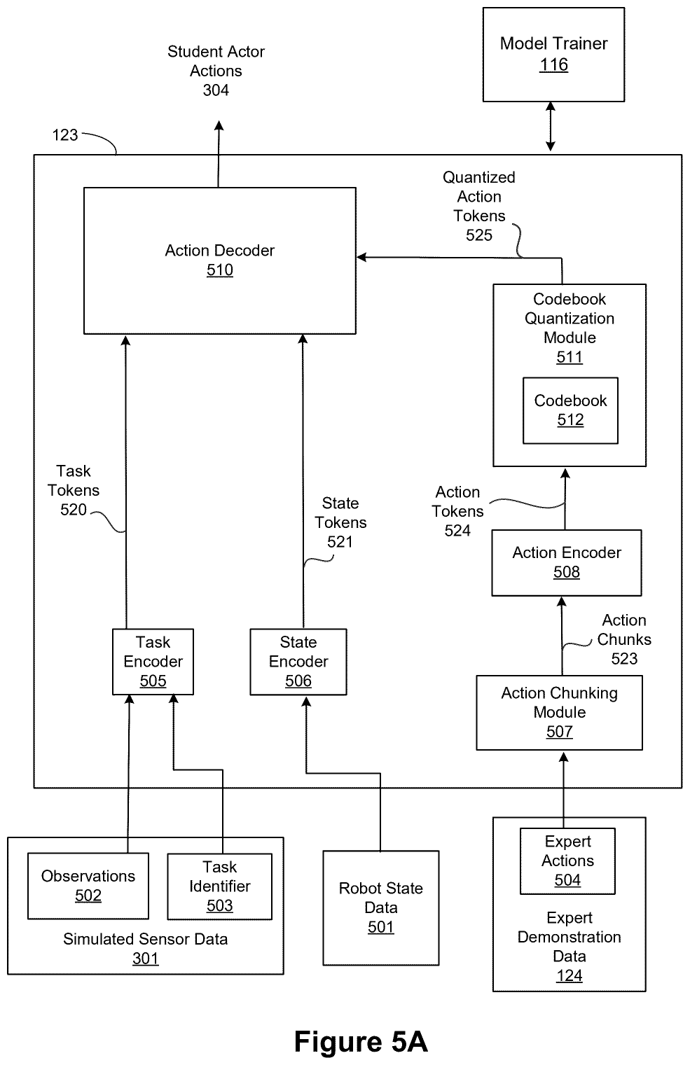

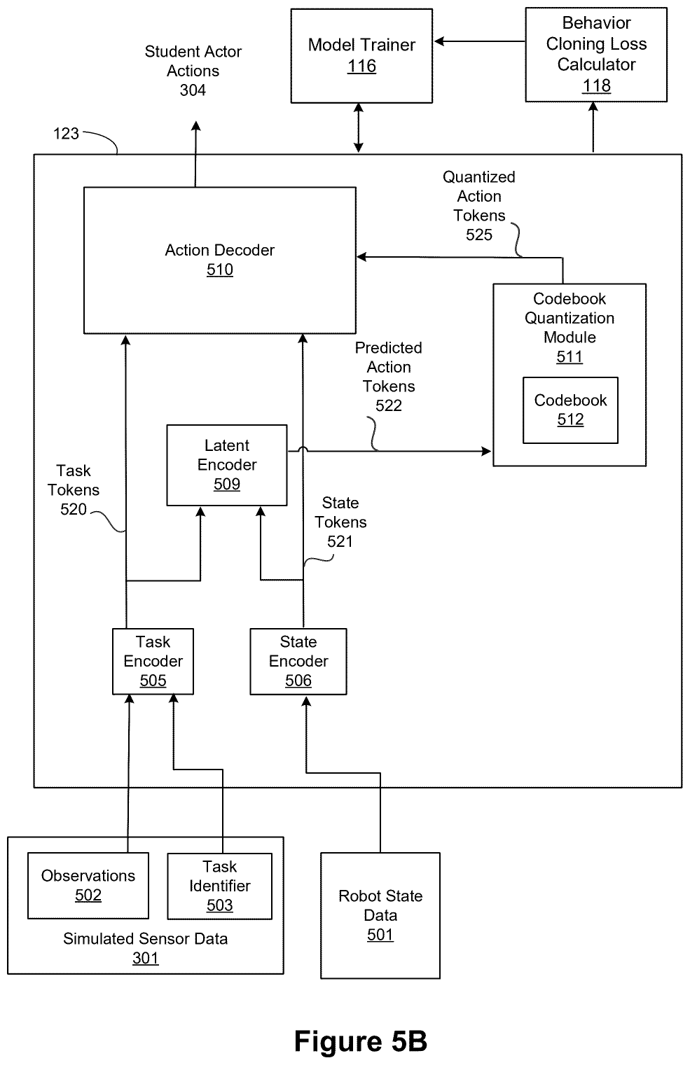

using a one-hot task index tᵢ for each task iϵ{1, 2, . . . , k}. Then, critic aggregator 119 uses the aggregated critic feedback to calculate a distillation loss 306. For example, distillation loss L_{distill} can be computed as:

$${L}_{distill} = \frac{1}{\vert D \vert} {\sum }_{s , o , {t}_{i} ∈ D} [ - {Q}_{agg} ( s , {π}_{{θ}_{student}} ( s , o , {t}_{i} ) ) \cdot {t}_{i} ] , \qquad ( Equation 8 )$$

where D represents expert demonstration data 124. Behavior cloning loss calculator 118 compares student actor actions 304 with expert actions included in expert demonstration data 124 and calculates behavior cloning loss 307. In some embodiments, distillation loss 306 is an objective from Dataset Aggregation (Dagger) technique used for learning policies from demonstration (e.g. Lₜₒₜₐₗ=L_{DAgger}). In the DAgger objective, a student policy π_{θ}_{_{student}} and expert policy Ite expert are used, where the DAgger objective is defined as:

$${L}_{DAgger} = - {𝔼}_{s ∼ {ρ}_{{π}_{β}}} {‖ {π}_{{θ}_{student}} ( s ) - {π}_{{θ}_{expert}} ( s ) ‖}^{2} , \qquad ( Equation 9 )$$

where ρ_{π}_{_{β}} is the state distribution induced by following a mixture policy π_{β}, and βϵ[0,1] mixes both student and expert policies to sample actions from π_{θ}_{_{student}} with probability β and actions from π_{θ}_{ₑₓₚₑᵣₜ} with probability 1−β. In various embodiments, student actor model 123 uses a sequential token prediction technique to generate predicted actions â_{t:t+1} and student actor model 123 is trained in two phases, which is described in more detail in conjunction with FIGS. 5A and 5B. In various embodiments, reinforcement learning module 310 uses distillation loss 306 and behavior cloning loss 307 to calculate a total loss defined as

$${L}_{t otal} = α {L}_{BC} + {L}_{distill} , \qquad ( Equation 10 )$$

where α is a hyperparameter that controls the relative weight of the behavior cloning loss 307. Reinforcement learning module 310 optimizes the parameters of student actor model 123 θ_{student} by minimizing the total loss function Lₜₒₜₐₗ. For example, the parameters can be updated as follows:

$${θ}_{student} ← {θ}_{student} - {α}_{student} {∇}_{{θ}_{student}} {L}_{total} , \qquad ( Equation 11 )$$

where α_{student} is the learning rate for student actor model 123. In some embodiments, model trainer 116 trains student actor model 123 iteratively until a stopping criterion is met, such as reaching a maximum number of iterations, a plateauing loss function, and/or the like. Once the training of student actor model 123 is complete, model trainer 116 stores student actor model 123 in data store 120, or elsewhere.

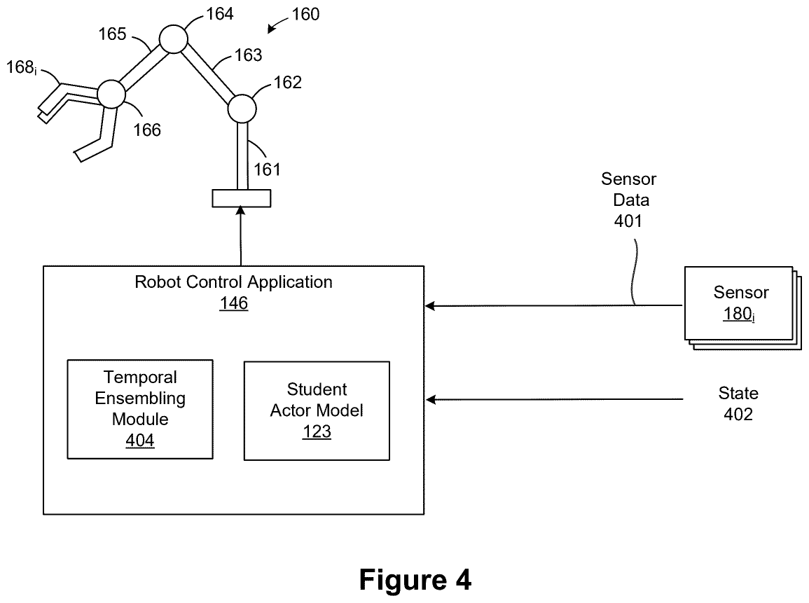

FIG. 4 is a more detailed illustration of the robot control application 146 of FIG. 1, according to various embodiments. As shown, robot control application 146 uses the trained student actor model 123 and a temporal ensembling module 404 to process state 401 of robot 160 received from one or more I/O devices (not shown) as well as sensor data 401 received from sensors 180 to control robot 160.

In operation, robot control application 146 receives sensor data 401 from sensors 180 and state 402 of robot 160 received from one or more I/O devices. Sensor data 401 can include visual data from cameras, tactile feedback from force sensors, joint angles from encoders, position and orientation data from inertial measurement units (IMUs), proximity measurements from LIDAR or ultrasonic sensors, and/or the like. Additionally, sensor data 401 includes one or more task identifiers, one or more current observations, and a goal observation. Goal observation, which can include information such as an image of the desired final configuration of robot 160, or an object in the environment that robot 160 needs to interact with. The trained student actor model 123 processes state 402 and sensor data 401 to generate student actor actions 304 for robot 160 to perform at least part of a task, such as adjusting the position of the robotic arm, modulating grip strength, navigating through an environment, and/or the like. In some embodiments, student actor model 123 makes real-time decisions to optimize task completion performance of robot 160, adapt robot 160 to dynamic environments, and execute at least parts of tasks, such as picking and placing objects, avoiding obstacles, maintaining precise contact during manipulation, and/or the like. In various embodiments, student actor actions 304 generated in action chunks may not be smoothly connected when executed over time. Temporal ensembling module 404 takes the action chunks from the previous I timesteps and combines the action chunks to generate a final smooth action for the current timestep t. In some examples, temporal ensembling module 404 averages multiple past actions chunks to generate the final action at the current timestep, smoothing abrupt transitions between actions chunks over time. For example, temporal ensembling module 404 could exponentially average multiple generated student actor actions 304 for a single timestep t from past l chunks, denoted as

$${a}_{t}^{t - l : t}$$

using the following equation:

$${a}_{t} = {\sum }_{i = 1}^{l} {w}_{i} {a}_{t}^{t - i} where {w}_{i} = exp ( - η i ) \qquad ( Equation 12 )$$

In Equation 12, wᵢ are the exponentially decaying weights, and η controls the rate of decay. The ensembled action aₜ is a weighted combination of the past l generated action chunks at timestep t, smoothing the final output. In some embodiments, robot control application 146 uses a low-level controller (not shown) to translate the high-level actions generated by the student actor model 123 into specific motor commands or actuator signals. The low-level controllers can include Proportional-Integral-Derivative (PID) controllers, impedance controllers, model predictive controllers, and/or the like, and ensure precise execution of the student actor actions 304 by adjusting joint velocities, positions, and forces of robot 160 in real time.

In various embodiments, robot control application 146 continues generating student actor actions 304 until the one or more current observations included in sensor data 401 match a goal observation. For example, in a stacking task, robot control application 146 compares the position and orientation of the boxes, captured via visual data from cameras or position sensors included in sensor data 401, against the reference coordinates and alignment specified in the goal observation. The task is considered complete when the position and orientation of the stacked boxes fall within predefined thresholds, such as a tolerance of ±1 cm for placement accuracy. In some examples, robot control application 146 uses visual recognition algorithms to confirm that observations from sensor data 401 match the goal observation. For example, robot control application 146 could use object detection to verify that an object has been placed in the correct location or orientation by comparing real-time images from the robot's camera included in sensors 180 to the final configuration specified in the goal observations.

In some embodiments, student actor model 123 is trained on various robotic tasks and generalizes the learned policies across various robotic tasks, which allows robot 160 to perform different types of operations, ranging from object manipulation to obstacle avoidance, leveraging task-specific knowledge from the training as described in conjunction with FIGS. 3A and 3B. For example, during training, student actor model 123 could have learned task-specific policies for grasping, navigating, balancing, and/or the like, and student actor model 123 can generalize task-specific policies to new robotic tasks, such as assembling parts, stacking objects, cleaning, and/or the like, during real-world operation.

FIG. 5A is a more detailed illustration of the first phase of training of the student actor model 123 of FIG. 1, according to various embodiments. In some embodiments, model trainer 116 performs a two-phase training process for student actor model 123. In the first phase, described in conjunction with FIG. 5A, model trainer 116 focuses on building a quantized representation of actions using codebook 512, by training state encoder 506, action encoder 508, and action decoder 510 using expert demonstration data 124, simulated sensor data 301, and robot state data 501. During the first phase, action encoder 508 processes action chunks 523 generated from expert demonstration data 124, generating continuous action embeddings that are then quantized by codebook 512 into discrete latent codes. The discrete latent codes establish a structured action space that supports further refinement in the second phase. In the second phase, which is described in conjunction with FIG. 5B, model trainer 116 uses the trained codebook 512 to train latent encoder 509 and retrain action decoder 510 based on simulated sensor data 301 and robot state data 501. Model trainer 116 further trains student actor model 123, aligning the predicted actions generated by latent encoder 509 with the discrete latent codes defined by the trained codebook 512 in the first phase.

As shown, student actor model 123 includes, without limitation, a task encoder 505, a state encoder 506, an action chunking module 507, an action encoder 508, a codebook quantization module 511, and a latent encoder 509. During training, student actor model 123 uses observations 502 and task identifier 503 included in simulated sensor data 301, as well as robot state data 501.

Task encoder 505 is a machine learning model, such as a neural network, which processes observations 502 and task identifier 503 and generates task tokens 520. In various embodiments, task encoder 505 encodes task-specific information by transforming task identifier 503, which indicates the task being executed, into task tokens 520. Task encoder 505 also processes observations 502, such as image renderings of the current state of the robot or the goal state of the task, to generate task tokens 520, which are task-specific embeddings. Task tokens 520 capture the context of the task and helps guide student actor model 123. For example, in a grasping task, the task encoder 505 could generate task tokens 520 based on task identifier 503 associated with grasping, as well as visual observations of the object to be grasped and the target position. Similarly, in a navigation task, task encoder 505 could encode the task identifier 503 and observations 502 of the robot surroundings to generate task tokens 520 that conditions student actor model 123 to move towards a specific goal. Task tokens 520 ensure that student actor model 123 correctly interprets the context of different robotic tasks and enables generalization across robotic tasks, whether the task is manipulating an object, navigating an environment, or interacting with other dynamic elements. In some examples, task encoder 505, denoted by ϕₜₐₛₖ, processes the goal observation im_{goal} (e.g., the goal image, representing the target state of robot 160) and the one or more current observations im_{curr} (e.g., the current image, representing the current state of robot 160) included in observations 502 and t; as the task identifier 503 and generates task tokens 520:

$${z}_{task} = {ϕ}_{task} ( i {m}_{curr} , {im}_{goal} , {t}_{i} ) . \qquad ( Equation 13 )$$

In some embodiments, task encoder 505 is implemented using Reusable Representations for Robotics (R3M), which is a pre-trained vision model designed to extract meaningful task-relevant features from raw visual inputs, such as images or videos. R3M is trained on large-scale datasets to learn generalizable visual representations that can be applied across different robotic tasks, allowing task encoder 505 to process high-dimensional visual inputs included in observations 502 and encode high-dimensional visual inputs into task tokens 520.

State encoder 506 is a machine learning model, such as a neural network, which processes states 501 included in privileged data 305 and generates state tokens 521. State tokens 521 represent a compact, encoded version of privileged data 305, such as the joint positions, velocities, forces, or other internal states of robot 160 that are not directly available from sensor data. In some embodiments, state encoder 506, denoted by ϕₛₜₐₜₑ, processes a recent sequence of robot states s_{t-h:t} over a horizon h included in privileged data 305 and generates state tokens 521, denoted by zₛₜₐₜₑ:

$${z}_{state} = {ϕ}_{state} ( {s}_{t - h : t} ) . \qquad ( Equation 14 )$$

In some embodiments, state encoder 506 is implemented as an MLP.

Action chunking module 507 processes expert actions 504 included in expert demonstration data 124 and generates action chunks 523. In various embodiments, action chunking module 507 groups multiple expert actions 504 into a batched sequence a_{t:t+1} to the reduce the effective horizon of the robotic task.

Action encoder 508 is a machine learning model, such as a neural network, which processes action chunks 523 and generates action tokens 524. In various embodiments, action encoder 508 constructs an embedding space for each action chunk a_{t:t+1} by encoding each action chunk as a vector-quantized latent code zₑ ϵ [symbol] ⁿ^{_{q}}. In some embodiments, the encoding is done by mapping a continuous action chunk to a latent embedding

$${z}_{e} = {ϕ}_{e n c}^{a c t} ( {a}_{t : t + l} ) \qquad ( Equation 15 )$$

In some examples, action encoder 508 can include a multi-headed attention model.

Codebook quantization module 511 (e.g. a quantization oracle) processes action tokens and generates quantized action tokens 525. As shown, codebook quantization module 511 includes, without limitation, a codebook 512. In various embodiments, codebook quantization module 511 uses codebook 512, denoted by C, which includes a set of n_{c} latent vectors, each with n_{q}-dimensional embedding vectors eᵢ. The latent vectors are used to quantize the action tokens 522 zₑ by mapping latent vectors to the nearest neighbor within codebook 512

$$c = arg {min}_{{e}_{i} ∈ C} {‖ {z}_{e} - {e}_{i} ‖}_{1} , \qquad ( Equation 16 )$$

which yields the vector-quantized latent variable e_{c}:

$${z}_{q} ( {ϕ}_{e n c} ( {a}_{t : t + l} ) ) = {e}_{c} . \qquad ( Equation 17 )$$

In at least one embodiment, codebook 512 C is first trained to encode action chunks 523 a_{t:t+1} using action encoder 508 described in Equation 15. Codebook quantization module 511 quantizes the generated zₑ into a one-hot vector for selecting the corresponding code within codebook 512, generating quantized action tokens 525 (e.g., the latent quantized code) z_{q} as described in Equation 17. In some embodiments, zₑ is treated as the logits of a softmax function to obtain a probability distribution σ(zₑ), which samples c from the resulting multinomial distribution:

$$c ∼ M ( σ ( {z}_{e} ) ) . \qquad ( Equation 18 )$$

Action decoder 510 is a machine learning model, such as a neural network, which processes quantized action tokens 525 and generates student actor actions 304. In various embodiments, action decoder 510, denoted by ψ_{dec}, processes the quantized action tokens 525 z_{q} which are discrete latent codes obtained from the codebook 512 and generates an action chunk â_{t:t+k}, which represent the predicted actions for a sequence of future time steps. The predicted student actor actions 304 â_{t:t+k} guide the behavior of robot 160 during both training and real-world operation, allowing the student actor model 123 to perform robot tasks such as object manipulation, navigation, or obstacle avoidance. In some examples, Action decoder 510 generates the predicted action sequence as follows:

$${\hat{a}}_{t : t + k} = {ψ}_{d e c} ( {z}_{q} , {z}_{s t a t e} , {z}_{t a s k} ) . \qquad ( Equation 19 )$$

In some examples, action decoder 510 can be implemented as a transformer.

In various embodiments, during training of student actor model 123, initially action decoder 510, codebook 512, and action encoder 508 are trained together, which focuses on learning a quantized representation of the expert actions 504 through codebook 512. Specifically, action encoder 508 processes action chunks 523 a_{t:t+k} and generates action tokens 524 in terms of continuous latent codes zₑ. The latent codes are then quantized by codebook 512 to produce discrete latent codes z_{q}. During training, model trainer 116 minimizes two loss functions: the reconstruction loss L_{act} and the code alignment loss L_{code}. The reconstruction loss L_{act} ensures that the predicted student actor actions 304 from action decoder 510 accurately match the ground truth expert actions 504 from the expert demonstration data 124. In some examples, the reconstruction loss is computed as follows:”

$${L}_{a c t} = \frac{1}{l} {\sum }_{i = t}^{t + l} {‖ {\hat{a}}_{i} - {a}_{i} ‖}_{1} \qquad ( Equation 20 )$$

where âᵢ, as described in Equation 19, are the predicted student actor actions 304 generated by action decoder 510 based on the quantized action tokens 525 z_{q}, state tokens 521 zₛₜₐₜₑ, and task tokens 520 zₜₐₛₖ, and aᵢ is the ground truth action chunk from expert demonstration data 124. The code alignment loss L_{code}, on the other hand, ensures that the action tokens 524 in terms of continuous latent codes zₑ generated by action encoder 508 align with the discrete latent codes z_{q} from codebook 512. In some examples, the code alignment loss is the distance between the continuous and discrete codes, which is calculated using the following equation:

$${L}_{c o d e} = {‖ {z}_{e} - S G ( {z}_{q} ) ‖}_{1} + {‖ SG ( {z}_{e} ) - {z}_{q} ‖}_{1} , \qquad ( Equation 21 )$$

where the stop-gradient (SG) operation prevents gradients from flowing through the quantized code z_{q}. In some embodiments, model trainer 116 updates action encoder 508, codebook 512, and action decoder 510 by minimizing the codebook loss function is given by:

$${L}_{c o d e b o o k} = {L}_{a c t} + {L}_{c o d e} \qquad ( Equation 22 )$$

Once the training of codebook 512 is complete, the trained codebook 512 is then used in the next phase of training student actor model 123 as described in more detail in conjunction with FIG. 5B.

FIG. 5B is a more detailed illustration of the second phase of training of the student actor model 123 of FIG. 1, according to various embodiments. As shown, student actor model 123 includes, without limitation, a latent encoder 509. In the second phase of training student actor model 123, latent encoder 509 is trained and action decoder 510 is retrained using the trained codebook 512.

Latent encoder 509 is a machine learning model, such as a neural network, which processes task tokens 520 and state tokens 521 and generates predicted action tokens 522. In various embodiments, latent encoder 509, denoted by

$${ϕ}_{enc}^{lat} ,$$

processes task tokens 520 zₜₐₛₖ and action tokens zₛₜₐₜₑ and generates predicted action tokens 522 \hat{z}_{q}:

$${\hat{z}}_{q} = {ϕ}_{e n c}^{lat} ( {z}_{task} , {z}_{state} ) \qquad ( Equation 23 )$$

In some embodiments, predicted action tokens 522 are in terms of vector quantized latent codes, which are discretized representations of predicted actions.

In various embodiments, behavior cloning loss calculator 118 calculates a cross-entropy loss to align to match the codes z_{q} learned in the trained codebook 512 to predicted action tokens 522 \hat{z}_{q}. In some examples, behavior cloning loss calculator 118 calculates the following loss function:

$${L}_{lat} = C E ( {z}_{q} , {\hat{z}}_{q} ) , \qquad ( Equation 24 )$$

where CE is the cross entropy function. In some embodiments, behavior cloning loss calculator 118 also calculates the reconstruction loss as described in Equation 20 to retrain action decoder 510. Then, behavior cloning loss 307 is the combined cross entropy loss as given in Equation 24 and the reconstruction loss as given by Equation 20.

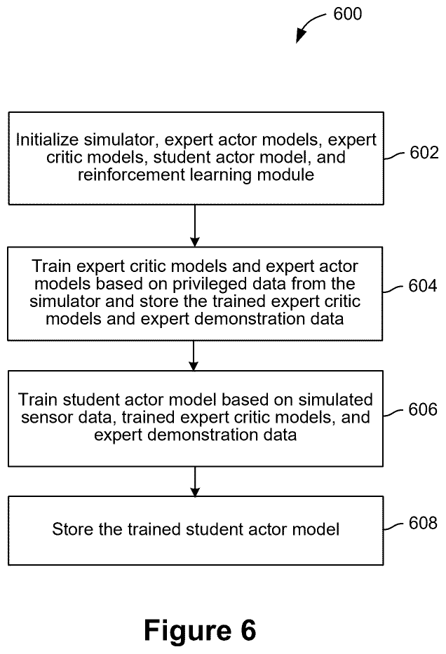

FIG. 6 sets forth a flow diagram of method steps for training the student actor model 123 of FIG. 1, according to various embodiments. Although the method steps are described in conjunction with the systems of FIGS. 1-5B, persons skilled in the art will understand that any system configured to perform the method steps in any order falls within the scope of the present disclosure.

As shown, a method 600 begins with step 602, where model trainer 116 initializes simulator 117, expert actor models 122, expert critic models 121, student actor model 123, and reinforcement learning module 310. In some embodiments, simulator 117 is initialized to simulate a robot task as well as various sensors. For example, in some embodiments, simulator 117 can be set up to simulate multiple parallel simulation environments, such as parallel simulation environments executing on different processors (e.g., different GPUs), that generate both privileged data 302 and simulated sensor data 301. Model trainer 116 initializes the parameters for the expert actor models 122, expert critic models 121, and student actor model 123 with random values. The initialization is typically done using a Gaussian or uniform distribution to ensure an unbiased starting point for each model. For example, parameters in the expert actor models 122 and expert critic models 121 could be initialized with values drawn from a Gaussian distribution centered at zero with a standard deviation that reflects the scale of the robotic tasks being trained on. In addition, the parameter l, which determines the size of the action chunks 523 and the prediction horizon of student actor actions 304, is set. For example, l=5 would mean that each action chunk 523 represents a sequence of five consecutive actions. In some embodiments, model trainer 116 initializes reinforcement learning module 310. The discount factor γ is set between 0 and 1, determining the importance of future rewards. A lower value for γ prioritizes immediate rewards, which can be suitable for short-horizon robotic tasks, whereas a higher value emphasizes long-term rewards, beneficial for robotics tasks needing a cumulative approach. The parameter k, representing the number of robotic tasks, is also initialized. For example, if k=10, model trainer 116 and simulator 117 are setup is designed to accommodate and differentiate between 10 distinct robotic tasks with each task being associated with an expert actor model 122 and an expert critic model 121 pair. Model trainer 116 also sets the number of data points N for each robotic task, which determines the quantity of expert demonstration data 124 collected per task. For example, N=1000 would mean that 1,000 data points (state, action, observations, and reward tuples) are collected and stored for each task in expert demonstration data 124. Furthermore, model trainer 116 initializes various learning rates that control the step size during gradient updates, such as α_{critic} as described in Equation 6, α_{actor} as described in Equation 5, and α_{student} as described in Equation 12. In various embodiments, model trainer 116 initializes the size n_{c} of codebook 512, representing the number of discrete latent vectors or embeddings, based on the diversity of action codes. For example, a codebook 512 size of 512 would provide 512 discrete embeddings to cover a range of actions. Model trainer 116 also initializes embedding dimensionality n_{q}, which is the dimensionality of each code in codebook 512, based on the complexity of the action space. For example, an n_{q}=64 means that each action code is represented in a 64-dimensional latent space.

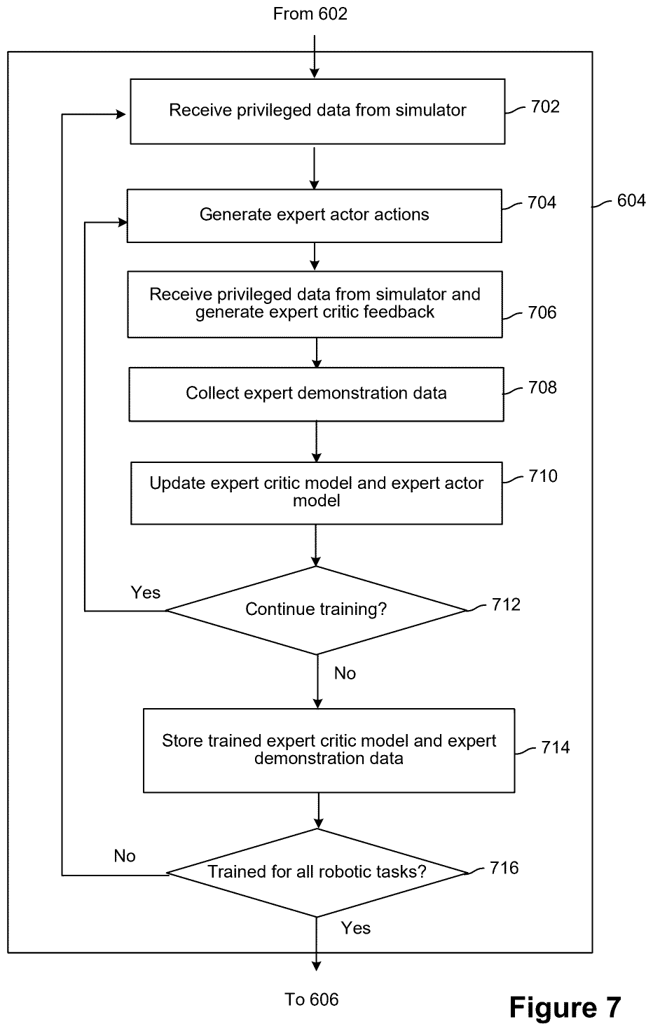

At step 604, model trainer 116 trains expert critic models 121 and expert actor models 122 based on privileged data 302 from the simulator 117 and stores the trained expert critic models 121 and expert demonstration data 124. In some embodiments, for each robotic task, simulator 117 generates privileged data 302, which an expert actor model 122 processes to generate expert actor actions 303. An expert critic model 122 processes privileged data 302 and expert actor actions 303 and generates expert critic feedback. Reinforcement learning module 310 uses the expert critic feedback to iteratively optimize the parameters of the expert critic model 122 and the expert actor model 121. In various embodiments, during training, expert demonstration data 124 is collected from simulator 117, which includes states, actions, observations, and rewards. Once expert critic models 121 and expert actor models 122 are trained for all robotic tasks, model trainer 116 stores expert demonstration data 124 and expert critic models 121 in datastore 120 or elsewhere. The method steps for training expert critic models 121 and expert actor models 122 are described in more detail in conjunction with FIG. 7.

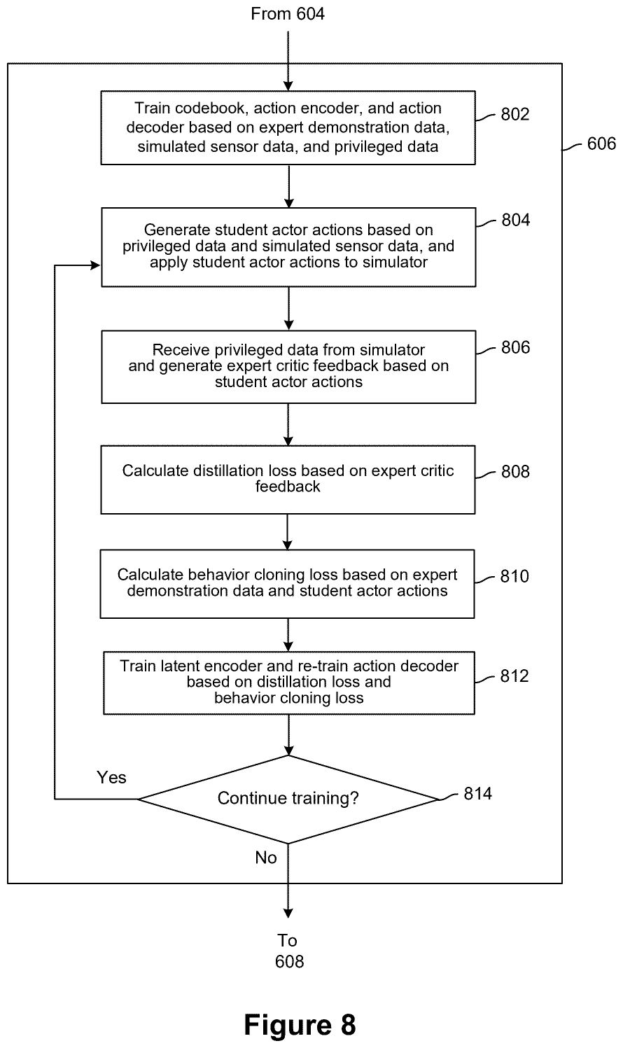

At step 606, model trainer 116 trains (1) student actor model 123 based on simulated sensor data 301, which is higher dimensional than privileged data, as well as (2) trained expert critic models 121, and (3) expert demonstration data 124. In some embodiments, simulator 117 generates privileged data 305 and simulated sensor data 301. Student expert actor model 121 processes simulated sensor data 301 and privileged data 305 and generates student actor actions 304. Expert critic models 122 that has been trained according to step 604 processes privileged data 305 and student actor actions 304 and generates expert critic feedback. Critic aggregator 119 processes expert critic feedback and generates distillation loss 306. Behavior cloning loss calculator 118 processes expert demonstration data 124 and student actor actions 304 and generates behavior cloning loss 307. Reinforcement learning module 310 uses distillation loss 306 and behavior cloning loss 307 to iteratively optimize the parameters of student actor model 123. The method steps for training student actor model 123 are described in more detail in conjunction with FIG. 8.

At step 608, model trainer 116 stores the trained student actor model 123. In some embodiments, model trainer 116 can store the trained student actor model 123 in data store 120 or elsewhere.

FIG. 7 sets forth a flow diagram of method steps for training expert critic models 121 and expert actor model 122 at step 604 of method 600, according to various embodiments. Although the method steps are described in conjunction with the systems of FIGS. 1-5B, persons skilled in the art will understand that any system configured to perform the method steps in any order falls within the scope of the present disclosure.

As shown at step 702, expert actor model 122 receives privileged data 302 from simulator 117. In some embodiments, simulator 117 generates random privileged data 302, which includes current state of robot 160 and the environment.

At step 704, expert actor model 122 generates expert actor actions 303. In some embodiments, expert actor model 122 processes privileged data 302 from simulator 117 to generate expert actor actions 303. Expert actor actions 303 are applied to robot 160 in simulator 117, for example, causing robot 160 to perform at least part of a task. Simulator 117 simulates robot 160 and the environment, moving to the next state.

At step 706, expert critic model 121 receives privileged data 302 from simulator 117. In some embodiments, expert critic model 122 receives the state of robot 160 and the environment after an expert actor action 303 is applied. In some embodiments, expert critic model 122 evaluates expert actor actions 303 by estimating the expected cumulative reward as described in Equation 2, starting from the state of robot 160 following expert actor actions 303. Additionally, expert critic model 121 calculates a value function, which represents the expected cumulative reward starting from the next state of robot 160. Expert critic model 122 processes both privileged data 302 and expert actor actions 303 to generate expert critic feedback.

At step 708, model trainer 116 collects expert demonstration data 124. Expert demonstration data 124 is generated during steps 704 and 706, such as the states of robot 160, expert actor actions 303, and the rewards. Additionally, expert demonstration data 124 includes observations from simulator 117, such as sensor readings that capture various aspects of the simulated environment.

At step 710, reinforcement learning module 301 updates expert critic model 121 and expert actor model 122. In some embodiments, reinforcement learning module 310 maximizes the expected reward in Equation 1 by updating the parameters of expert actor model 122 based on the expert critic feedback. In some embodiments, reinforcement learning module 310 updates the parameters of expert critic model 121 to reduce the TD error described in Equation 3 based on the loss function in Equation 4. In some embodiments, reinforcement learning module 310 iteratively updates both the expert actor model 122 and the expert critic model 121 using an update rule, for example, the update rules described in Equation 5 and Equation 6.

At step 712, model trainer 610 checks whether to continue training. In some embodiments, model trainer 116 checks whether a stopping criterion is met, such as reaching a maximum number of iterations, a plateauing loss function, and/or the like. If the stopping criterion is met, the method proceeds to step 714. If the stopping criterion is not met, the method returns to step 704.

At step 714, model trainer 610 stores trained expert critic model 121 and expert demonstration data 124. In various embodiments, model trainer 610 stores expert demonstration data 124 and the trained expert critic models 121 in datastore 120 or elsewhere.

At step 716, model trainer 610 checks whether expert critic models 121 and expert actor models 122 are trained for all robotic tasks. If expert critic models 121 and expert actor models 122 are trained for all robotic tasks, the method 600 proceeds to step 606. If expert critic models 121 and expert actor models 122 are not trained for all robotic tasks, the method returns to step 702 to train expert critic model 121 and expert actor model 122 for another robotic task.

FIG. 8 sets forth a flow diagram of method steps for training the student actor model 123 at step 606 of method 600, according to various embodiments. Although the method steps are described in conjunction with the systems of FIGS. 1-5B, persons skilled in the art will understand that any system configured to perform the method steps in any order falls within the scope of the present disclosure.

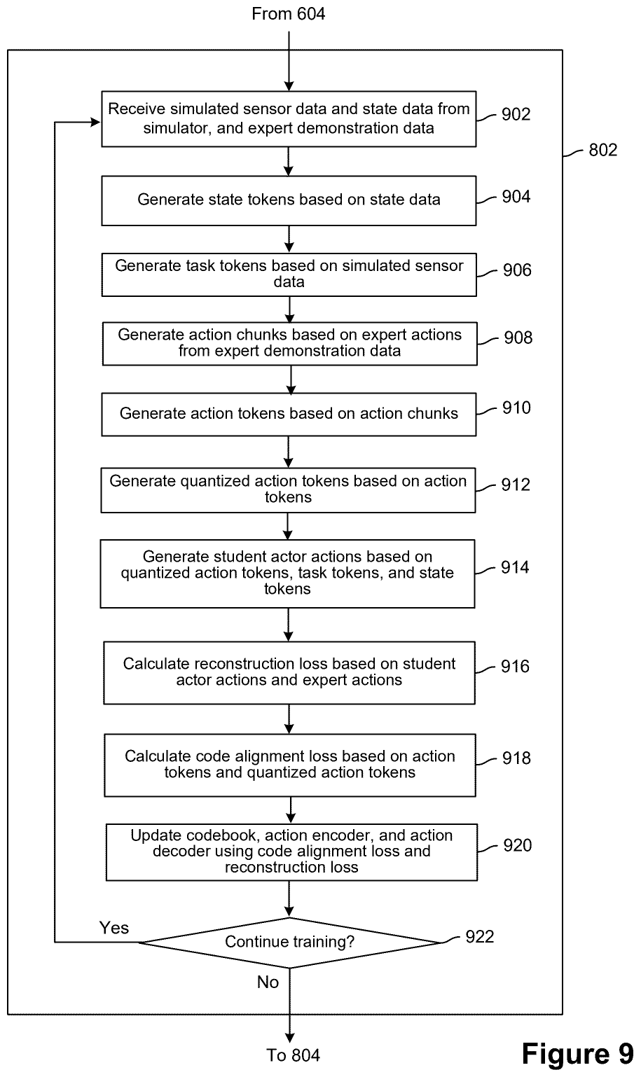

As shown at step 802, model trainer 116 trains codebook 512, action encoder 508, and action decoder 510 based on expert demonstration data 124, simulated sensor data 301, and privileged data 305. In various embodiments, task encoder 505 processes observations 502 and task identifier 503 and generates task tokens 520. In some embodiments, task encoder 505 is implemented as a pre-trained vision model such as R3M. State encoder 521 processes states 501 included in privileged data 305 and generate state tokens 521. Concurrently or sequentially, action chunking module 507 processes expert actions 504 included in expert demonstration data collected at step 708 and generate action chunks 523. Action encoder 508 processes action chunks 523 and generates action tokens 524, which can be continuous latent codes. Codebook quantization module 511 then uses codebook 512 to quantize the latent codes by mapping the latent codes to discrete representations, generating quantized action tokens 525. Action decoder 510 processes quantized action tokens 525, task tokens 520, and state tokens 521 and generates predicted student actor actions 304 that are aligned with the expert demonstration data 124. In some embodiments, model trainer 116 minimizes two loss functions: a reconstruction loss, which ensures that the predicted student actor actions 304 match expert actions 504, and a code alignment loss, which aligns action tokens 524 (e.g., the continuous latent codes) with the discrete representations (e.g., codes) in codebook 512. The method steps for training codebook 512, action encoder 508, and action decoder 510 are described in more detail in conjunction with FIG. 9.

At step 804, student actor model 123 generates student actor actions 304 based on privileged data 305 and simulated sensor data 301 and applies student actor actions 304 to simulator 117. In at least one embodiment, student actor model 123 generates student actor actions 304 in action chunks over a prediction horizon which is initialized at step 602. In various embodiments, task encoder 505 processes observations 502 and task identifier 503 included in simulated sensor data 301 and generate task tokens 520. State encoder 506 processes states 501 included in privileged data 305 and generates state tokens 521. Latent encoder 509 processes task tokens 520 and state tokens 521 and generates predicted action tokens 522. Codebook quantization module 511 uses codebook 512, which was trained at step 802 to quantize predicted action tokens 522 and generate quantized action tokens 525. Action decoder 510, which was also trained at step 802, processes task tokens 520, state tokens 521, and quantized action tokens 525 and generates student actor actions 304.

At step 806, the trained expert critic models 121, receive privileged data 305 from simulator 117 and generate expert critic feedback based on student actor actions 304.

For each robotic task, expert critic model 121 processes privileged data 305 and student actor actions 304 generated at step 804 and generates expert critic feedback in terms of value-based estimates providing an evaluation of how optimal the student actor actions 304 are for each specific task. For example, expert critic feedback can be in terms of the expected cumulative reward if the student actor model 123 were to continue generating student actor actions 304.

At step 808, critic aggregator 119 calculates distillation loss 306 based on expert critic feedback. In various embodiments, critic aggregator 119 gathers expert critic feedback from various expert critic models 121, each trained for a specific task, and compiles various expert critic feedback into aggregated expert critic feedback that reflects the collective evaluation of the student actor actions 304 across tasks. In some embodiments, for each specific task, critic aggregator 119 selects the relevant expert critic feedback using a one-hot task index. Additionally, critic aggregator 119 uses the aggregated expert critic feedback to calculate the distillation loss, as described in Equation 8. In some embodiments, distillation loss 306 is derived from the DAgger technique with distillation loss 306 as described in Equation 9.

At step 810, behavior cloning loss calculator 118 calculates behavior cloning loss 307 based on expert demonstration data 124 and student actor actions 304. In some embodiments, behavior cloning loss calculator 118 calculates the reconstruction loss, as described in Equation 20, to verify that the predicted student actor actions 304 from action decoder 510 closely match the ground truth expert actions 305 included in the expert demonstration data 124. Additionally, behavior cloning loss calculator 118 calculates a cross-entropy loss, as described in Equation 24, to align the predicted action tokens 522 generated by latent encoder 509 with the codes learned in codebook 512 at step 802. Behavior cloning loss calculator 118 combines reconstruction loss from Equation 20 and the cross-entropy loss from Equation 24 generating behavior cloning loss 307.

At step 812, reinforcement learning module 310 trains latent encoder 509 and re-train action decoder 510 based on distillation loss 306 and behavior cloning loss 307. In various embodiments, reinforcement learning module 310 uses a total loss, as described in Equation 10, which is a weighted combination of behavior cloning loss 307 and distillation loss 306. A hyperparameter, a, adjusts the relative influence of behavior cloning loss 307 in the total loss calculation, enabling fine-tuning of the balance between learning from expert actions 504 and aggregating expert critic feedback. By iteratively minimizing the total loss, reinforcement learning module 310 updates the parameters of latent encoder 509 and retrains action decoder 510 included in student actor model 123. For example, reinforcement learning module 310 can use the update rule in Equation 11 to update the parameters of student actor model 123.

At step 814, model trainer 116 checks whether to continue training. In some embodiments, model trainer 116 checks whether a stopping criterion is met, such as reaching a maximum number of iterations, a plateauing loss function, and/or the like. If the stopping criterion is met, the method 600 proceeds to step 608. If the stopping criterion is not met, the method returns to step 804.

FIG. 9 sets forth a flow diagram of method steps for training codebook 512, action encoder 508, and action decoder 510 of student actor model 123 at step 802, according to various embodiments. Although the method steps are described in conjunction with the systems of FIGS. 1-5A, persons skilled in the art will understand that any system configured to perform the method steps in any order falls within the scope of the present disclosure.

As shown, at step 902, student actor model 123 receives simulated sensor data 301 and robot state data 501 from simulator 117 and expert demonstration data 124. In various embodiments, task encoder 505 receives observations 502 and task identifier 503 included in simulator sensor data 301. State encoder 506 receives robot state data 501. Action chunking module 507 receives expert actions 504 included in expert demonstration data 124.

At step 904, state encoder 506 generates state tokens 520 based on robot state data 501. In some embodiments, state encoder 506 processes a recent sequence of robot states over a fixed horizon h, as described in Equation 14. The fixed horizon is initialized at step 602.

At step 906, task encoder 505 generates task tokens based on simulated sensor data 301. In various embodiments, task encoder 505 processes observations 502 and task identifier 503 included in simulated sensor data 301 and generates task tokens 520. In some examples, task encoder 505 processes the goal observation, the one or more current observations included in observations 502 and task identifier 503 and generates task tokens 520 as described in Equation 13.

At step 908, action chunking module 507 generates action chunks 523 based on expert actions 504 from expert demonstration data 124. In various embodiments, action chunking module 507 chunks expert actions 504 into action chunks 523 of fixed length. In some embodiments, the length of each action chunk 523 is initialized at step 602. In various embodiments, steps 904-908 are carried out concurrently or sequentially.

At step 910, action encoder 508 generates action tokens 524 based on action chunks 523. In various embodiments, action encoder 508 constructs an embedding space for each action chunk 523 by encoding each action chunk 523 as a vector-quantized latent code. In some embodiments, the encoding is done by mapping a continuous action chunk 523 to a latent embedding as described in Equation 15.

At step 912, codebook quantization module 511 generates quantized action tokens 525 based on action tokens 524. In various embodiments, codebook quantization module 511 uses codebook 512 to process action tokens 524 and generate quantized action tokens 525. In various embodiments, codebook quantization module 511 uses one or more latent vectors (e.g., codes) included in codebook 512 to quantize the action tokens 522 by mapping latent vectors to the nearest neighbor within codebook 512 as described in Equation 16, yielding a vector quantized latent variable as described in Equation 17. In at least one embodiment, codebook quantization module 511 quantizes the generated action tokens 524 into a one-hot vector for selecting the corresponding code within codebook 512. In some embodiments, action tokens 524 are treated as the logits of a softmax function to obtain a probability distribution as described in Equation 18.

At step 914, action decoder 510 generates student actor actions 304 based on quantized action tokens 525, task tokens 520, and state tokens 521. In various embodiments, action decoder 510 processes the quantized action tokens 525 generated at step 912, which are discrete latent codes obtained from the codebook 512, task tokens 520 generated at step 906, and state tokens generated at step 94, and generates predicted student actor actions 304 for a sequence of future time steps as described in Equation 19.

At step 916, model trainer 116 calculates a reconstruction loss based on student actor actions 304 and expert actions 504. In some embodiments, model trainer 116 calculates reconstruction loss as described in Equation 20 using student actor actions 304 and expert actions 504.

At step 918, model trainer 116 calculates a code alignment loss based on action tokens 524 and quantized action tokens 525. In some embodiments, model trainer 116 calculates code alignment loss as described in Equation 21 using on action tokens 524 and quantized action tokens 525.

At step 920, model trainer 116 updates codebook 512, action encoder 508, and action decoder 510 using code alignment loss and reconstruction loss. In some embodiments, model trainer 116 updates action encoder 508, codebook 512, and action decoder 510 by minimizing the codebook loss function as described by Equation 22.

At step 922, model trainer 116 checks whether to continue training. In some embodiments, model trainer 116 checks whether a stopping criterion is met, such as reaching a maximum number of iterations, a plateauing loss function, and/or the like. If the stopping criterion is met, the method proceeds to step 804. If the stopping criterion is not met, the method returns to step 902.

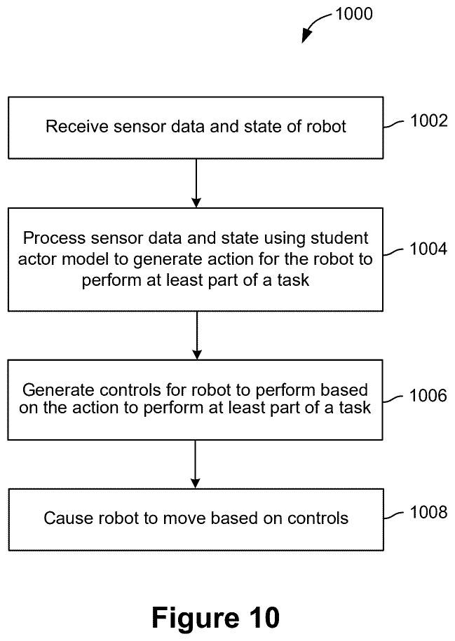

FIG. 10 sets forth a flow diagram of method steps for controlling a robot 160 using a trained student actor model 123, according to various embodiments. Although the method steps are described in conjunction with the systems of FIGS. 1-5B, persons skilled in the art will understand that any system configured to perform the method steps in any order falls within the scope of the present disclosure.

As shown, a method 1000 begins with step 1002, where robot control application 146 receives sensor data 401 and state 402 of robot 160. In various embodiments, robot control application 146 receives sensor data 401 from sensors 180 and state 402 of robot 160 from one or more I/O devices.

At step 1004, robot control application 146 processes sensor data 401 and state 402 using student actor model 123 to generate action for the robot 160 to perform at least part of a task. In some embodiments, student actor model 123 makes real-time decisions to optimize task completion performance of robot 160, adapt robot 160 to dynamic environments, and execute at least parts of tasks. In various embodiments, student actor actions 304 uses temporal ensembling module 404 to generate a smooth action over time. In some examples, temporal ensembling module 404 uses a weighted average over multiple past actions chunks to generate the smooth action at the current timestep, such as using Equation 12.

At step 1006, robot control application 146 generates controls for robot 160 based on action to perform at least part of a task. In some embodiments, robot control application 146 can use a low-level controller to translate the high-level actions generated by the student actor model 123 into specific motor commands or actuator signals for robot 160. In some other embodiments, robot control application 146 can transmit the student actor action 304 to another controller that generates the specific motor commands or actuator signals for robot 160.

At step 1008, robot control application 146 causes robot 160 to move based on the controls. In some embodiments, robot control application 146 applies controls generated at step 1006 to adjust joint velocities, positions, and/or forces of robot 160 in real time.

In sum, techniques are disclosed for multi-task robot control using asymmetric critic-guided student models. The disclosed techniques include a two-stage training approach. In the first stage, expert actor models and expert critic models are trained on various tasks using privileged data, such as joint positions of a robot, forces, velocities, and states of objects within a virtual environment, that are generated by a simulator. During the first stage of training, expert demonstration data is collected based on the actions generated by the expert actor models. In the second stage, a student actor model, which processes sensor data, such as visual inputs and proprioceptive data, is trained using a combination of a behavior cloning loss derived from the expert demonstration data and a distillation loss calculated using the trained expert critic models in the first stage. The aggregate feedback uses evaluations from various expert critic models corresponding to various tasks that are being performed during training. After training, the student actor model can be deployed to control a robot by processing real-world sensor inputs and generating robot actions to perform multiple tasks.

At least one technical advantage of the disclosed techniques relative to prior art is that the disclosed techniques enable robot control systems to generalize across multiple tasks, without requiring task-specific retraining. The disclosed techniques use expert critic feedback from various trained expert critic model and a structured action space through a trained codebook for cross-task learning, reducing the need for laborious manual data collection and retraining for each new task. Another advantage of the disclosed techniques is that, by using a multi-stage training approach that combines expert critic models trained on privileged data with a high-dimensional student model, the disclosed techniques facilitate faster adaptation to new tasks or changing conditions. These technical advantages provide one or more technological improvements over prior art approaches.

1. In some embodiments, a computer-implemented method for training a machine learning model to control a robot comprises performing, based on a first set of robot data, one or more training operations to generate one or more first trained machine learning models for performing one or more robotic tasks, expert demonstration data, and one or more trained evaluation models, and performing, based on the expert demonstration data, a set of sensor data, and first feedback generated by the one or more trained evaluation models, one or more training operations to generate a second trained machine learning model to control a robot for a plurality of robotic tasks.

2. The computer-implemented method of clause 1, wherein performing one or more training operations to generate the one or more first trained machine learning models, the expert demonstration data, and the one or more trained evaluation model comprises processing the first set of robot data using an untrained machine learning model to generate an action, processing the first set of robot data and the action using an untrained evaluation model to generate second feedback, updating one or more parameters of the untrained machine learning model based on the second feedback and the first set of robot data, and updating one or more parameters of the untrained evaluation model based on the first set of robot data and the action.

3. The computer-implemented method of clauses 1 or 2, wherein the expert demonstration data includes at least one of one or more states, one or more actions, one or more observations, or one or more rewards associated with the one or more robotic tasks.

4. The computer-implemented method of any of clauses 1-3, wherein performing one or more training operations to generate the second trained machine learning model comprises processing the set of sensor data using an untrained machine learning model to generate an action, computing a first loss based on the action and the expert demonstration data, processing robot state data and the action using the one or more trained evaluation models to generate the first feedback, computing a second loss based on the first feedback, and updating one or more parameters of the untrained machine learning model based on the first loss and the second loss.

5. The computer-implemented method of any of clauses 1-4, wherein the second trained machine learning model comprises a task encoder configured to process the set of sensor data to generate one or more task tokens, a state encoder configured to process robot state data to generate one or more state tokens, a latent encoder configured to process the one or more state tokens and the one or more task tokens to generate one or more predicted action tokens, a quantization oracle configured to process, based on a codebook, the one or more action tokens to generate one or more quantized action tokens, and an action decoder configured to process the one or more quantized action tokens, the one or more state tokens, and the one or more task tokens to generate an action.

6. The computer-implemented method of any of clauses 1-5, wherein the codebook comprises one or more discrete latent codes.

7. The computer-implemented method of any of clauses 1-6, wherein performing one or more training operations to generate the second machine learning model further comprises generating, based on the one or more action chunks, the one or more action tokens, generating, based on the one or more action tokens and the codebook, the one or more quantized action tokens, and generating, based on the one or more state tokens, the one or more task tokens, and the one or more quantized action tokens, the action.

8. The computer-implemented method of any of clauses 1-7, wherein performing one or more training operations to generate the second machine learning model further comprises computing, based on the one or more discrete latent codes and the one or more action tokens, a third loss, computing, based on the action and the second set of data, a fourth loss, and updating one or more parameters of the action encoder, the codebook, and the action decoder based on the third loss and the fourth loss.

9. The computer-implemented method of any of clauses 1-8, wherein performing one or more training operations to generate the second machine learning model further comprises generating the one or more predicted action tokens, generating, based on the one or more predicted action tokens, one or more quantized action tokens, and generating, based on the one or more state tokens, the one or more task tokens, and the one or more quantized action tokens, the action.

10. The computer-implemented method of any of clauses 1-9, wherein performing one or more training operations to generate the second machine learning model further comprises computing, based on the action and the second set of data, the fourth loss, computing, based on the one or more latent codes and the one or more predicted action tokens, a fifth loss, and updating one or more parameters of the trained action encoder and the latent encoder based on the fourth loss and the fifth loss.

11. In some embodiments, one or more non-transitory computer-readable media include instructions that, when executed by one or more processors, cause the one or more processors to perform the steps of performing, based on a first set of robot data, one or more training operations to generate one or more first trained machine learning models for performing one or more robotic tasks, expert demonstration data, and one or more trained evaluation models, and performing, based on the expert demonstration data, a set of sensor data, and first feedback generated by the one or more trained evaluation models, one or more training operations to generate a second trained machine learning model to control a robot for a plurality of robotic tasks.

12. The one or more non-transitory computer-readable media of clause 11, wherein the instructions, when executed by the one or more processors, further cause the one or more processors to perform the steps of processing the first set of robot data using an untrained machine learning model to generate an action, processing the first set of robot data and the action using an untrained evaluation model to generate second feedback, updating one or more parameters of the untrained machine learning model based on the second feedback and the first set of robot data, and updating one or more parameters of the untrained evaluation model based on the first set of robot data and the action.

13. The one or more non-transitory computer-readable media of clauses 11 or 12, wherein the instructions, when executed by the one or more processors, further cause the one or more processors to perform the steps of processing the set of sensor data using an untrained machine learning model to generate an action, computing a first loss based on the action and the expert demonstration data, processing robot state data and the action using the one or more trained evaluation models to generate the first feedback, computing a second loss based on the first feedback, and updating one or more parameters of the untrained machine learning model based on the first loss and the second loss.

14. The one or more non-transitory computer-readable media of any of clauses 11-13, wherein the second trained machine learning model comprises a task encoder configured to process the set of sensor data to generate one or more task tokens, a state encoder configured to process robot state data to generate one or more state tokens, a latent encoder configured to process the one or more state tokens and the one or more task tokens to generate one or more predicted action tokens, a quantization oracle configured to process, based on a codebook, the one or more action tokens to generate one or more quantized action tokens, and an action decoder configured to process the one or more quantized action tokens, the one or more state tokens, and the one or more task tokens to generate an action.

15. The one or more non-transitory computer-readable media of any of clauses 11-14, wherein the task encoder is pre-trained vision model.

16. The one or more non-transitory computer-readable media of any of clauses 11-15, wherein the codebook comprises one or more discrete latent codes.

17. The one or more non-transitory computer-readable media of any of clauses 11-16, wherein the instructions, when executed by the one or more processors, further cause the one or more processors perform one or more training operations to generate the second machine learning model comprising generating, based on the one or more action chunks, the one or more action tokens, generating, based on the one or more action tokens, the one or more quantized action tokens, generating, based on the one or more state tokens, the one or more task tokens, and the one or more quantized action tokens, the action, computing, based on the one or more discrete latent codes and the one or more action tokens, a third loss, computing, based on the action and the second set of data, a fourth loss, and updating one or more parameters of the action encoder, the codebook, and the action decoder based on the third loss and the fourth loss.

18. The one or more non-transitory computer-readable media of any of clauses 11-17, wherein the third loss is a codebook loss and the fourth loss is a reconstruction loss.

19. The one or more non-transitory computer-readable media of any of clauses 11-18, wherein the instructions, when executed by the one or more processors, further cause the one or more processors to perform one or more training operations to generate the second machine learning model comprising generating the one or more predicted action tokens, generating, based on the one or more predicted action tokens, one or more quantized action tokens, generating, based on the one or more state tokens, the one or more task tokens, and the one or more quantized action tokens, the action, computing, based on the action and the second set of data, the fourth loss, computing, based on the one or more latent codes and the one or more predicted action tokens, a fifth loss, and updating one or more parameters of the trained action encoder and the latent encoder based on the fourth loss and the fifth loss.

20. In some embodiments, a system comprises a memory storing instructions, and a processor that is coupled to the memory and, when executing the instructions, is configured to perform the steps of perform, based on a first set of robot data, one or more training operations to generate one or more first trained machine learning models for performing one or more robotic tasks, expert demonstration data, and one or more trained evaluation models, and perform, based on the expert demonstration data, a set of sensor data, and first feedback generated by the one or more trained evaluation models, one or more training operations to generate a second trained machine learning model to control a robot for a plurality of robotic tasks.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model to control a robot, the method comprising:
performing, based on a first set of robot data, one or more training operations to generate one or more first trained machine learning models for performing one or more robotic tasks, expert demonstration data, and one or more trained evaluation models; and
performing, based on the expert demonstration data, a set of sensor data, and first feedback generated by the one or more trained evaluation models, one or more training operations to generate a second trained machine learning model to control a robot for a plurality of robotic tasks.

2. The computer-implemented method of claim 1, wherein performing one or more training operations to generate the one or more first trained machine learning models, the expert demonstration data, and the one or more trained evaluation model comprises:
processing the first set of robot data using an untrained machine learning model to generate an action;
processing the first set of robot data and the action using an untrained evaluation model to generate second feedback;
updating one or more parameters of the untrained machine learning model based on the second feedback and the first set of robot data; and
updating one or more parameters of the untrained evaluation model based on the first set of robot data and the action.

3. The computer-implemented method of claim 1, wherein the expert demonstration data includes at least one of one or more states, one or more actions, one or more observations, or one or more rewards associated with the one or more robotic tasks.

4. The computer-implemented method of claim 1, wherein performing one or more training operations to generate the second trained machine learning model comprises:
processing the set of sensor data using an untrained machine learning model to generate an action;
computing a first loss based on the action and the expert demonstration data;
processing robot state data and the action using the one or more trained evaluation models to generate the first feedback;
computing a second loss based on the first feedback; and
updating one or more parameters of the untrained machine learning model based on the first loss and the second loss.

5. The computer-implemented method of claim 1, wherein the second trained machine learning model comprises:
a task encoder configured to process the set of sensor data to generate one or more task tokens;
a state encoder configured to process robot state data to generate one or more state tokens;
a latent encoder configured to process the one or more state tokens and the one or more task tokens to generate one or more predicted action tokens;
a quantization oracle configured to process, based on a codebook, the one or more action tokens to generate one or more quantized action tokens; and
an action decoder configured to process the one or more quantized action tokens, the one or more state tokens, and the one or more task tokens to generate an action.

6. The computer-implemented method of claim 5, wherein the codebook comprises one or more discrete latent codes.

7. The computer-implemented method of claim 5, wherein performing one or more training operations to generate the second machine learning model further comprises:
generating, based on the one or more action chunks, the one or more action tokens;
generating, based on the one or more action tokens and the codebook, the one or more quantized action tokens; and
generating, based on the one or more state tokens, the one or more task tokens, and the one or more quantized action tokens, the action.

8. The computer-implemented method of claim 5, wherein performing one or more training operations to generate the second machine learning model further comprises:
computing, based on the one or more discrete latent codes and the one or more action tokens, a third loss;
computing, based on the action and the second set of data, a fourth loss; and
updating one or more parameters of the action encoder, the codebook, and the action decoder based on the third loss and the fourth loss.

9. The computer-implemented method of claim 5, wherein performing one or more training operations to generate the second machine learning model further comprises:
generating the one or more predicted action tokens;
generating, based on the one or more predicted action tokens, one or more quantized action tokens; and
generating, based on the one or more state tokens, the one or more task tokens, and the one or more quantized action tokens, the action.

10. The computer-implemented method of claim 5, wherein performing one or more training operations to generate the second machine learning model further comprises:
computing, based on the action and the second set of data, the fourth loss;
computing, based on the one or more latent codes and the one or more predicted action tokens, a fifth loss; and
updating one or more parameters of the trained action encoder and the latent encoder based on the fourth loss and the fifth loss.

11. One or more non-transitory computer-readable media including instructions that, when executed by one or more processors, cause the one or more processors to perform the steps of:
performing, based on a first set of robot data, one or more training operations to generate one or more first trained machine learning models for performing one or more robotic tasks, expert demonstration data, and one or more trained evaluation models; and
performing, based on the expert demonstration data, a set of sensor data, and first feedback generated by the one or more trained evaluation models, one or more training operations to generate a second trained machine learning model to control a robot for a plurality of robotic tasks.

12. The one or more non-transitory computer-readable media of claim 11, wherein the instructions, when executed by the one or more processors, further cause the one or more processors to perform the steps of:
processing the first set of robot data using an untrained machine learning model to generate an action;
processing the first set of robot data and the action using an untrained evaluation model to generate second feedback;
updating one or more parameters of the untrained machine learning model based on the second feedback and the first set of robot data; and
updating one or more parameters of the untrained evaluation model based on the first set of robot data and the action.

13. The one or more non-transitory computer-readable media of claim 11, wherein the instructions, when executed by the one or more processors, further cause the one or more processors to perform the steps of:
processing the set of sensor data using an untrained machine learning model to generate an action;
computing a first loss based on the action and the expert demonstration data;
processing robot state data and the action using the one or more trained evaluation models to generate the first feedback;
computing a second loss based on the first feedback; and
updating one or more parameters of the untrained machine learning model based on the first loss and the second loss.

14. The one or more non-transitory computer-readable media of claim 11, wherein the second trained machine learning model comprises:
a task encoder configured to process the set of sensor data to generate one or more task tokens;
a state encoder configured to process robot state data to generate one or more state tokens;
a latent encoder configured to process the one or more state tokens and the one or more task tokens to generate one or more predicted action tokens;
a quantization oracle configured to process, based on a codebook, the one or more action tokens to generate one or more quantized action tokens; and
an action decoder configured to process the one or more quantized action tokens, the one or more state tokens, and the one or more task tokens to generate an action.

15. The one or more non-transitory computer-readable media of claim 14, wherein the task encoder is pre-trained vision model.

16. The one or more non-transitory computer-readable media of claim 14, wherein the codebook comprises one or more discrete latent codes.

17. The one or more non-transitory computer-readable media of claim 14, wherein the instructions, when executed by the one or more processors, further cause the one or more processors perform one or more training operations to generate the second machine learning model comprising:
generating, based on the one or more action chunks, the one or more action tokens;
generating, based on the one or more action tokens, the one or more quantized action tokens;
generating, based on the one or more state tokens, the one or more task tokens, and the one or more quantized action tokens, the action;
computing, based on the one or more discrete latent codes and the one or more action tokens, a third loss;
computing, based on the action and the second set of data, a fourth loss; and
updating one or more parameters of the action encoder, the codebook, and the action decoder based on the third loss and the fourth loss.

18. The one or more non-transitory computer-readable media of claim 17, wherein the third loss is a codebook loss and the fourth loss is a reconstruction loss.

19. The one or more non-transitory computer-readable media of claim 14, wherein the instructions, when executed by the one or more processors, further cause the one or more processors to perform one or more training operations to generate the second machine learning model comprising:
generating the one or more predicted action tokens;
generating, based on the one or more predicted action tokens, one or more quantized action tokens;
generating, based on the one or more state tokens, the one or more task tokens, and the one or more quantized action tokens, the action;
computing, based on the action and the second set of data, the fourth loss;
computing, based on the one or more latent codes and the one or more predicted action tokens, a fifth loss; and
updating one or more parameters of the trained action encoder and the latent encoder based on the fourth loss and the fifth loss.

20. A system comprising:
a memory storing instructions; and
a processor that is coupled to the memory and, when executing the instructions, is configured to perform the steps of:
perform, based on a first set of robot data, one or more training operations to generate one or more first trained machine learning models for performing one or more robotic tasks, expert demonstration data, and one or more trained evaluation models; and
perform, based on the expert demonstration data, a set of sensor data, and first feedback generated by the one or more trained evaluation models, one or more training operations to generate a second trained machine learning model to control a robot for a plurality of robotic tasks.
